(19) United States
(12) Patent Application Publication
(10) Pub. No.: US 2026/0321169 A1
(43) Pub. Date: Oct. 15, 2026

(54) PROJECTION DEVICE

(71) Applicant: Inmersia Computers S.L., Barcelona (ES)

(72) Inventors: Guillem DE LA TORRE ROVIRA, Barcelona (ES); Otman MAHYOU AMARKI, Barcelona (ES); Dorian TREPTOW, Barcelona (ES)

(21) Appl. No.: 19/483,870

(22) PCT Filed: May 12, 2023
(86) PCT No.: PCT/IB2023/000246

§ 371 Date: Nov. 12, 2025

(51) Int. Cl. G09G 3/00; G02B 27/01; G06F 3/01

(52) U.S. Cl. CPC G09G 3/003; G02B 27/0172; G06F 3/013; G02B 2027/0123; G09G 2340/0407; G09G 2354/00

(57) ABSTRACT

An optical system for a near-eye projection of an image into an eye of a user, the optical system comprising: a projection portion configured to project light encoding the image, and a foveation portion comprising at least one switchable optical element controllable to switch between a foveal mode and a peripheral mode, wherein in the foveal mode, the foveation portion is configured to project the light from the projection portion on a central region of a retina of the eye, and in the peripheral mode, the foveation portion is configured to project the light from the projection portion on a peripheral region of the retina, the peripheral region being larger than and comprising the central region. Corresponding methods and projection devices are also provided.

### TECHNICAL FIELD

Example aspects herein relate to a near-eye projection of an image into a user's eye, and in particular to an optical system, a projection device and a method.

### BACKGROUND

Optical systems for projecting light into a user's eye (or eyes) are used in extended reality (XR) settings, such as augmented reality, virtual reality, or mixed reality. These optical systems are used to form a virtual image that can either be combined with light incident from an environment viewed by the user (in the case of the augmented or mixed reality), or that can recreate a virtual environment viewed by the user(in the case of virtual reality).

Typically, the elements of the optical system are placed near the user's eye (i.e. these are optical systems for near-eye projection of images), so the image projection can be made with a more compact optical system, which helps improve portability and user convenience. For example, the elements of these optical systems may be part of a device worn or held by the user such as a head-mounted display.

To provide an immersive user experience, the virtual image projected into the user's eye should be adapted to the field of view currently seen by the user. In particular, the light projected into the user's eye reaches a specific part of the retina, which in turns determines how the virtual image will be seen by the user, such that the orientation of the projected light, and in particular the angle at which the light enters the user's eye, should be adapted to the user.

Accordingly, there is a need for an optical system and a method which enhance the user experience, and in particular to provide a more immersive user experience, by improving the adaptability of the virtual image projected into the user's eye.

In particular, the virtual image may be adapted to the user's field of view by projecting the light such that it converges at a point in the eye that coincides with the eye's centre of rotation point, thus allowing the image to always be centred on the retina of the eye. However, this causes the light to only be projected on a small portion of the retina due to the angle of incidence of the light being limited by the pupil of the eye. This in turn limits the size of the virtual image seen by the user.

There is therefore a need for an optical system and a method with improved adaptability to the user's field of view whilst allowing the light to be projected on a wider part of the retina.

In addition, optical systems have limited resources, in terms of size, battery life, computing resources, etc. There is therefore a need for an optical system and a method which improves the user experience whilst improving compactness and suppressing any increase in required resources.

### SUMMARY

According to a first example aspect, there is provided an optical system for a near-eye projection of an image into an eye of a user, the optical system comprising a projection portion and a focusing portion, wherein the projection portion is configured to project light encoding the image, and the focusing portion is configured to converge the light to at least one convergent point so as to cause the projected light to enter the eye and form an image on the retina, wherein the at least one convergent point is located on a convergent arc on or near a pupil of the eye, wherein a respective location of each convergent point on the convergent arc corresponds to an angle of rotation of the eye about an ocular rotation axis, the convergent arc having a centre of curvature substantially coincident with the ocular rotation axis.

By causing the projected light to be convergent on a point that lies on the convergent arc, the projected light may enter at a greater angle of incidence than in the case where the light is convergent on a point near the centre of ocular rotation, thus allowing a larger image to be displayed to the user, and the projected light may enter the eye across an angular range that can be kept centred on the retina, therefore avoiding a so-called window effect.

Thus, the virtual image projected into the user's eye is better adapted to the user's field of view, thereby improving user experience.

Preferably, a distance between the centre of curvature and the centre of ocular rotation is 1.5 cm or less, more preferably 1 cm or less, and most preferably 0.5 cm or less.

Reducing a distance between the centre of curvature of the convergent arc and the centre of ocular rotation allows the field-of-view provided by the optical system to be increased.

Preferably, a distance between the arc and the pupil remains substantially constant regardless of the angle of rotation of the eye.

Accordingly, a range of incidence angle of projected light rays that enter the eye may be kept substantially constant regardless of the angle of rotation of the eye (i.e. the orientation of the pupil), and the image may be projected onto the same area of the retina, so that the user sees a virtual image with a substantially constant size.

Preferably, the optical system is configured to move the at least one convergent point so that a central portion of the image coincides substantially with a central region of a retina of the eye, preferably a macula of the retina, and more preferably one of a perifovea, a parafovea, a fovea, a foveal avascular zone, a foveola, and an umbo of the retina.

By causing the convergent point to move on the convergent arc, the light may continue to enter as the eye rotates whilst avoiding an increase in the energy required to project the light into the eye (relative to a case where light is converged onto a plurality of distinct convergent points corresponding to different angles of rotation of the eye).

Preferably, the optical system further comprises a steering portion configured to move the at least one convergent point about the convergent arc in response to a rotation of the eye about an ocular rotation axis, the arc having a centre of curvature substantially coincident with the ocular rotation axis.

Preferably, the steering portion is configured to move at least one element of the projection portion and the focusing portion.

Preferably, the steering portion comprises at least one optical element for steering the light from the projection portion towards the focusing portion.

Preferably, the at least one optical element comprises a steerable mirror.

Preferably, the at least one optical element comprises a plurality of switchable lens, each switchable lens having a respective orientation and configured to orient the light from the projection portion onto a different portion of the focusing portion, such that the focusing portion converges the light on a different convergent point on the convergent arc.

Accordingly, the location of the convergent point light may be changed by controlling the state of each switchable lens.

Preferably, the at least one optical element comprises an element with a controllable phase modulation.

Preferably, the projection portion is configured to project a plurality of light each encoding a respective portion of an image and the focusing portion is configured to converge each light on a corresponding one of a plurality of convergent points, the location of each convergent point on the convergent arc corresponding to a respective angle of rotation of the eye about the ocular rotation axis, such that the light converging on adjacent convergent points encode adjacent portions of the image.

Thus, depending on an angle of rotation of the eye, the light focused on a different one of the convergent points will coincide with the pupil of the eye and enter the eye, to form the (virtual) image on the retina.

By projecting light that converges on multiple convergent points simultaneously (which may be called a static eye-box), the optical system may be simplified and thus made more compact and requiring less resources, for example by omitting elements to move the convergent point or elements to track the position of the eye.

Preferably, the at least one convergent point is located on a convergent surface, the convergent surface being substantially parallel to the pupil of the eye and comprising the convergent arc.

The convergent surface may have a centre of curvature substantially coinciding with the centre of ocular rotation. The convergent surface may substantially coincide with the surface of the sphere approximating the eye, or the convergent surface may be a surface substantially parallel to the surface of the sphere with a greater or smaller radius of curvature, with a centre of curvature that is shifted relative to the centre of the sphere, or both, as explained above in the case of the convergent arc.

The optical system may be configured to move the at least one convergent point on the convergent surface along both dimensions on the surface, or the optical system may be configured to project light to a plurality of convergent points on the convergent surface (not necessarily simultaneously) where the convergent points are spaced apart from each other (or distributed) along both dimensions on the convergent surface.

Accordingly, the projected light may continue to enter the eye even in case of a rotation of the eye about both ocular rotation axes (or about the centre of ocular rotation).

Preferably, the projection portion is configured to project first light encoding a first image for a first eye of the user and to project second light encoding a second image for a second eye of the user, and the focusing portion is configured to converge the first light to at least one first convergent point so as to cause the projected light to enter the first eye and form an image on the retina of the first eye, and to converge the second light to at least one second convergent point so as to cause the projected light to enter the second eye and form an image on the retina of the second eye.

Accordingly, the optical system may project a stereoscopic image, thus giving the user an impression of depth in the virtual image.

Preferably, the projection portion comprises a first projection part configured to project the first light, and a second projection part configured to project the second light, and/or the focusing portion comprises a first focusing part and a second focusing part, the first focusing part being configured to converge the first light to the at least one first convergent point, and the second focusing part being configured to converge the second light to the at least one second convergent point.

Accordingly, each part of the projection portion and/or the focusing portion may be controlled individually to project the image into the user's eyes.

Preferably, the projection portion comprises a display configured to emit the image to be displayed, and a focusing element for converging the light rays towards the focusing portion, wherein, optionally, the projection portion comprises a spatial filter for receiving the converged light rays.

Preferably, the projection portion comprises a coherent light source, preferably a laser, configured to emit substantially coherent light, wherein, the projection portion optionally comprises at least one of a collimating element configured to collimate the substantially coherent light, a phase modulator configured to encode the image by modulating the substantially coherent light, and a laser beam scanning system comprising at least one steerable mirror.

Preferably, the optical system further comprises a foveation portion configured to switch between a foveal mode and a peripheral mode, wherein in the foveal mode, the foveation portion is configured to project the light from the projection portion on a central region of a retina of the eye, and in the peripheral mode, the foveation portion is configured to project the light from the projection portion on a peripheral region of the retina, the peripheral region being larger than and comprising the central region.

As the central region of the retina has a higher sensitivity, the image projected in the foveal mode may have a higher resolution than the image projected in the peripheral mode, without causing a significant change in the quality of the image perceived by the user.

Accordingly, resource requirements (e.g. for resolution, bandwidth, light power, and computation) of the optical system may be reduced whilst avoiding a significant impact on the quality of the projected image.

Preferably, the projection portion in the optical system comprising the foveation portion is configured to project the light as substantially collimated light.

Preferably, the foveation portion is configured to increase an angular size of the light incident on the eye in the peripheral mode.

In other words, the angular size of the light projected on the eye is greater in the peripheral mode than in the foveal mode, (i.e. in the peripheral mode, light is incident on the pupil from a wider angular range).

Preferably, the foveation portion is configured to increase a focal length of the light incident on the eye in the foveal mode.

Preferably, the foveation portion comprises at least one focusing element having a controllable focal length.

Preferably, the foveation portion comprises at least one switchable optical element, and optionally, each of the at least one switchable element is configured to, when switched to a first state, allow the light to pass substantially without altering an angular size of the light.

Preferably, the at least one switchable optical element comprises a first switchable element having a first focal length and a second switchable element having a second focal length, the second focal length being different from the first focal length.

Preferably, the first switchable element is arranged at a first distance from the display and the second switchable element is arranged a second distance from the display,

Preferably, a difference between the first distance and the second distance is such that a convergent point of the first switchable element and a convergent point of the second switchable element coincide substantially with each other.

Preferably, in the foveal mode, the first switchable element is configured to be switched to a second state and the second switchable element is configured to be switched to a first state, and in the peripheral mode, the first switchable element is configured to be switched to a first state and the second switchable element is configured to be switched to a second state.

Preferably, the at least one switchable optical element comprises a first switchable diverging element, a first switchable converging element, and a second switchable converging element, wherein the first switchable diverging element is arranged a first distance from the projection portion, and the first switchable converging element is arranged a second distance from the projection portion, the second distance being greater than the first distance.

Preferably, in the foveal mode, the first switchable diverging element is configured to be switched to a first state, the first switchable converging element is configured to be switched to a first state, and the second switchable converging element is configured to be switched to a second state, such that the light from the projection portion is converged by the second switchable converging element to form an image on the central region of the retina, and in the peripheral mode, the first switchable diverging element is configured to be switched to a second state, the first switchable converging element is configured to be switched to a second state, and the second switchable converging element is configured to be switched to a first state, such that the light from the projection portion is diverged by the first switchable diverging element onto the first switchable converging element and converged by the first switchable converging element to form an image on the peripheral region of the retina.

Preferably, the second switchable converging element is arranged a third distance from the projection portion, such that a convergent point of the first switchable converging element and a convergent point of the second switchable converging element coincide substantially with each other.

Preferably, the at least one switchable optical element further comprises a second switchable diverging element, wherein the second switchable diverging element is configured to be switched to a second state in the foveal mode and to increase an angular size of the light converged by the first switchable converging element, wherein the second switchable converging element is arranged a third distance from the projection portion, and the second switchable diverging element is arranged a fourth distance from the projection portion, wherein the first distance, the second distance, the third distance and the fourth distance are configured such that a convergent point of the light in the foveal mode and a convergent point of the light in the peripheral mode coincide substantially with each other.

Preferably, the projection portion comprises a light-field display configured to project the light encoding a plurality of elemental images in a three-dimensional light field, each elemental image forming a part of the image.

Preferably, the projection portion comprises a phase modulator configured to project the light encoding a holographic image.

According to a second example aspect, there is provided an optical system for a near-eye projection of an image into an eye of a user, the optical system comprising: a projection portion configured to project light encoding the image, and a foveation portion comprising at least one switchable optical element controllable to switch between a foveal mode and a peripheral mode, wherein in the foveal mode, the foveation portion is configured to project the light from the projection portion on a central region of a retina of the eye, and in the peripheral mode, the foveation portion is configured to project the light from the projection portion on a peripheral region of the retina, the peripheral region being larger than and comprising the central region.

Using the at least one switchable optical element allows for a differentiation between the image projected onto the central region of the retina (e.g. the fovea) with a higher sensitivity and the image projected onto the peripheral region of the retina without requiring additional elements.

This allows for an image with a higher resolution to be projected onto the central region of the retina, which ensure a higher quality of the image perceived by the user. On the other hand, the image with a lower resolution may be projected onto the peripheral region of the retina, without affecting the quality of the image perceived by the user.

Accordingly, the optical system improves the user experience whilst improving compactness and suppressing any increase in required resources.

Preferably, the projection portion is configured to project the light as substantially collimated light.

Accordingly, the focal length of the light projected into the eye may be determined by the focal length of the switchable optical element(s).

Preferably, each of the at least one switchable element is configured to, when switched to a first state, allow the light to pass substantially without altering an angular size of the light.

Preferably, the foveation portion is configured to increase an angular size of the light incident on the eye in the peripheral mode.

Preferably, the foveation portion is configured to increase a focal length of the light incident on the eye in the foveal mode.

Preferably, the foveation portion comprises at least one focusing element having a controllable focal length.

Preferably, the at least one switchable optical element comprises a first switchable element having a first focal length and a second switchable element having a second focal length, the second focal length being different from the first focal length.

Preferably, the first switchable element is arranged at a first distance from the display and the second switchable element is arranged a second distance from the display.

Preferably, a difference between the first distance and the second distance is such that a convergent point of the first switchable element and a convergent point of the second switchable element coincide substantially with each other.

For example, the distance separating the second switchable element and the first switchable element (i.e. the difference between the second distance and the first distance) may be set based on the difference between the first focal length and the second focal length.

Accordingly, the light converges substantially at the same point regardless of whether the focal length of the light is altered by the first switchable element or by the second switchable element.

Preferably, in the foveal mode, the first switchable element is configured to be switched to a second state and the second switchable element is configured to be switched to a first state, and in the peripheral mode, the first switchable element is configured to be switched to a first state and the second switchable element is configured to be switched to a second state.

Preferably, the at least one switchable optical element comprises a first switchable diverging element, a first switchable converging element, and a second switchable converging element, wherein the first switchable diverging element is arranged a first distance from the projection portion, and the first switchable converging element is arranged a second distance from the projection portion, the second distance being greater than the first distance.

Preferably, in the foveal mode, the first switchable diverging element is configured to be switched to a first state, the first switchable converging element is configured to be switched to a first state, and the second switchable converging element is configured to be switched to a second state, such that the light from the projection portion is converged by the second switchable converging element to form an image on the central region of the retina, and in the peripheral mode, the first switchable diverging element is configured to be switched to a second state, the first switchable converging element is configured to be switched to a second state, and the second switchable converging element is configured to be switched to a first state, such that the light from the projection portion is diverged by the first switchable diverging element onto the first switchable converging element and converged by the first switchable diverging element to form an image on the peripheral region of the retina.

Preferably, the second switchable converging element is arranged a third distance from the projection portion, such that a convergent point of the first switchable converging element and a convergent point of the second switchable converging element coincide substantially with each other.

For example, the distance separating the second switchable converging element and the first switchable converging element (i.e. the difference between the third distance and the first distance) may be set based on the difference between the focal length of the second switchable converging element and the focal length of the first switchable converging element.

Preferably, the at least one switchable optical element further comprises a second switchable diverging element, wherein the second switchable diverging element is configured to be switched to a second state in the foveal mode and to increase an angular size of the light converged by the first switchable converging element, wherein the second switchable converging element is arranged a third distance from the projection portion, and the second switchable diverging element is arranged a fourth distance from the projection portion, wherein the first distance, the second distance, the third distance and the fourth distance are configured such that a convergent point of the light in the foveal mode and a convergent point of the light in the peripheral mode coincide substantially with each other.

Preferably, the foveation portion is configured to converge the light to at least one convergent point so as to cause the projected light to enter the eye and form an image on the retina, wherein the at least one convergent point is located on a convergent arc on or near a pupil of the eye, wherein a respective location of each convergent point on the convergent arc corresponds to an angle of rotation of the eye about an ocular rotation axis, the convergent arc having a centre of curvature substantially coincident with the ocular rotation axis.

Preferably, the optical system is configured to move the at least one convergent point so that a central portion of the image coincides substantially with a central region of a retina of the eye, preferably a macula of the retina, and more preferably one of a perifovea, a parafovea, a fovea, a foveal avascular zone, a foveola, and an umbo of the retina.

Preferably, the optical system further comprises a steering portion configured to move the at least one convergent point about the convergent arc in response to a rotation of the eye about an ocular rotation axis, the arc having a centre of curvature substantially coincident with the ocular rotation axis.

Preferably, the steering portion is configured to move at least one element of the projection portion and the foveation portion.

Preferably, the steering portion comprises at least one optical element for steering the light from the projection portion towards the foveation portion.

Preferably, the at least one optical element comprises a steerable mirror.

Preferably, the at least one optical element comprises a plurality of switchable lens, each switchable lens having a respective orientation and configured to orient the light from the projection portion onto a different portion of the foveation portion, such that the foveation portion converges the light on a different convergent point on the convergent arc.

Preferably, the at least one optical element comprises a phase modulator with controllable phase modulation.

Preferably, the projection portion is configured to project a plurality of light each encoding a respective portion of an image and the foveation portion is configured to converge each light on a corresponding one of a plurality of convergent points, the location of each convergent point on the convergent arc corresponding to a respective angle of rotation of the eye about the ocular rotation axis, such that the light converging on adjacent convergent points encode adjacent portions of the image.

Preferably, the at least one convergent point is located on a convergent surface, the convergent surface being substantially parallel to the pupil of the eye and comprising the convergent arc.

Preferably, a plurality of convergent points is distributed on the convergent surface, along both dimensions of the convergent surface.

Preferably, the optical system is configured to move the at least one convergent point along both dimensions of the convergent surface.

Preferably, the projection portion is configured to project first light encoding a first image for a first eye of the user and to project second light encoding a second image for a second eye of the user, and the foveation portion comprises two foveation parts each corresponding to a respective eye of the user, each foveation part being configured to switch between a foveal mode to project light on a central region of a retina of the corresponding eye and a peripheral mode to project the light on a peripheral region of the retina of the corresponding eye, the peripheral region being larger than and comprising the central region.

Preferably, the projection portion comprises a first projection part configured to project the first light, and a second projection part configured to project the second light.

Preferably, the projection portion comprises a display configured to emit the image to be displayed in substantially collimated light rays, and a focusing element for converging the light rays towards the foveation portion, wherein, optionally, the projection portion comprises a spatial filter for receiving the converged light rays.

Preferably, the projection portion comprises a coherent light source, preferably a laser, configured to emit substantially coherent light, wherein, the projection portion optionally comprises at least one of a collimating element configured to collimate the substantially coherent light, a phase modulator configured to encode the image by modulating the substantially coherent light, and a laser beam scanning system comprising at least one steerable mirror.

Preferably, the projection portion comprises a light-field display configured to project the light encoding a plurality of elemental images in a three-dimensional light field, each elemental image forming a part of the image.

Preferably, in the foveal mode, the foveation portion is configured to project the light encoding a first plurality of elemental images from the light-field display on the central region of a retina of the eye, and in the peripheral mode, the foveation portion is configured to project the light a second plurality of elemental images from the light-field display on the peripheral region of the retina, where the second plurality of elemental images are different from the first plurality of elemental images.

Preferably, the projection portion comprises a phase modulator configured to project the light encoding a holographic image.

Preferably, in the foveal mode, the foveation portion is configured to project the light encoding a first part of the holographic image on the central region of a retina of the eye, and in the peripheral mode, the foveation portion is configured to project the light encoding a second part of the holographic image on the peripheral region of the retina, where the first part and the second part of the holographic images are different from each other.

According to a third example aspect, there is provided a projection device comprising the optical system according to the first example aspect herein or according to the second example aspect herein, and at least one of: one or more eye tracker for determining an angle of rotation of the pupil of the eye, and a computing unit.

Optionally, each eye tracker comprises at least one camera for capturing an image of the eye, the eye tracker being configured to determine the angle of rotation of the pupil of the eye based on the image, the angle of rotation of the pupil being used to determine the location of the at least one convergent point on the convergent arc.

By tracking the angle of rotation of the pupil, the optical system may determine a position on the convergent arc (or on the convergent surface) that would allow the light to enter the eye. This may be used to either determine the position on the convergent arc to which the convergent point(s) should be moved (for example in the case of a dynamic eye-box) may be used to determine to which convergent points the light should be converged.

In case of a static eye-box, the optical system may determine, based on the angle of rotation of the pupil, a subset of one or more convergent points to which converge light encoding the image (because that light would enter the eye), and may selectively project light that would converge on convergent points in the subset only, thus reducing the energy required to project the image. In other words, the optical system may interrupt the projection of light that would converge on convergent points outside the subset.

Optionally, the eye tracker is configured to determine a focal length of the lens of the eye.

The tracker may, for example, determine an instantaneous focal length at recurring time instants (e.g. periodically, such as every millisecond), or upon detecting a predetermined trigger such as a movement of the eye.

Accordingly, the image projected into the eye can be adapted to the focal length of the eye. This allows, for example, to introduce artificial (or digital blur) to the image, to improve a perceived depth of elements in the virtual image.

Optionally, the eye tracker comprises at least one a light source for illuminating the eye.

Preferably, the light source is not detectable by the eye, to avoid affecting the image that is projected into the eye.

Preferably, the projection device is to be held or worn by the user.

Preferably, the projection device comprises a headset to be mounted on a head of the user.

Preferably, at least one element of the optical system is located in a housing on the headset.

Preferably, the computing unit configured to obtain a value indicative of an angle of rotation of the eye, and to generate one or more first control signals for causing the projection portion to project light rendering an image based on the indicated angle of rotation of the eye.

Preferably, the computing unit is configured to obtain the value from the one or more eye tracker.

Preferably, the computing unit is configured to determine a position on the convergent arc corresponding to the indicated angle of rotation of the eye, based on the obtained value, and to generate one or more second control signals for controlling at least one of the projection portion and the focusing portion, the one or more second control signals causing the light to be convergent at one or more convergent points corresponding to the determined position.

Preferably, the computing unit is configured to determine, based on the obtained value, a direction within a scene towards which the pupil is oriented, and to render a part of the scene corresponding to the direction.

Preferably, the optical system comprises a computing unit configured to: generate one or more first control signals for causing the projection portion to project light rendering a first part of the image for the central region of the retina and for causing the foveation portion to switch to the foveal mode, and generate one or more second control signals for causing the projection portion to project light rendering a second part of the image for the peripheral region of the retina and for causing the foveation portion to switch to the peripheral mode.

Preferably, the computing unit is configured to, by generating the one or more first control signals and the one or more second control signals, cause the projection portion and the foveation portion to switch substantially simultaneously, the projection portion switching between the projecting light rendering the first part and light rendering the second part, and the foveation portion switching between the foveal mode and the peripheral mode.

According to a fourth example aspect, there is provided a method for a near-eye projection of an image into an eye of a user, the method comprising: projecting light encoding the image, and converging the light to at least one convergent point so as to cause the projected light to enter the eye and form an image on the retina, wherein the at least one convergent point is located on a convergent arc on or near a pupil of the eye, wherein a respective location of each convergent point on the convergent arc corresponds to an angle of rotation of the eye about an ocular rotation axis, the convergent arc having a centre of curvature substantially coincident with the ocular rotation axis.

According to a fifth example aspect, there is provided a method for a near-eye projection of an image into an eye of a user, the optical system comprising: projecting light encoding the image, and controlling at least one switchable optical element to switch between a foveal mode and a peripheral mode, wherein in the foveal mode, the light encoding the image is projected by the at least one switchable optical element on a central region of a retina of the eye, and in the peripheral mode, the light encoding the image is projected by the at least one switchable optical element on a peripheral region of the retina, the peripheral region being larger than and comprising the central region.

Preferably, any of the optical system according to the first example aspect or according to the second example aspect, the projection device according to the third example aspect, the method according to the fourth example aspect or according to the fifth example aspect, is for projecting an extended reality, XR image, and more preferably one of an augmented reality, AR, a virtual reality, VR, or mixed reality, MR, image.

Preferably, the XR image comprises at least one virtual element representing digital information.

Preferably, each virtual element is either superimposed onto a physical environment of the user, captured by imaging means or seen by the user, or forms part of a virtual environment.

For simplicity, when approximating the eye as a sphere, the centre of the sphere may be defined as the centre of ocular rotation, and thus the rotation of the eye may be defined as a rotation about the centre of the sphere, that is the centre of ocular rotation. A rotation about the centre of ocular rotation point may also be defined as the rotation about two distinct ocular rotation axes intersecting at the centre of ocular rotation and are in a plane parallel to the pupil of the eye. The ocular rotation axes may be two axes defined according to Listing's law (e.g. the vertical and transverse axes of the eye), i.e. two axes lying in the eye's Listing's plane.

In certain aspects herein, the light projected into the eye is converged on at least one convergent point, in which case the at least one convergent point may be a point that is forward of the centre of ocular rotation, and substantially along the pupillary or foveal axis of the eye (i.e. a point that is likely to coincide with the pupil of the eye such that the light converging on the convergent point enters the eye and is projected onto the retina).

In certain aspects herein, the convergent point lies on a convergent arc. The centre of curvature of the convergent arc may be defined as an axis that coincides with one of the ocular rotation axes and a radius of curvature corresponding to the radius of the sphere approximating the eye. However, it would understood there may be a difference between the centre of curvature of the convergent arc and the centre of ocular rotation (i.e. centre of the sphere), a difference between the radius of curvature of the convergent arc and the radius of the sphere (preferably, a difference of 1 cm or less), or both, which may be caused by variations in the dimensions of human eyes.

If not coincident with the centre of the sphere, the centre of curvature of the convergent arc may be between the pupil and the centre of ocular rotation (e.g. in a volume around the pupillary axis or foveal axis of the eye, such as a cone having the iris of the eye as a base and the centre of ocular rotation as a vertex), or between the centre of ocular rotation and the retina of the eye (e.g. in a volume around the pupillary axis or foveal axis of the eye, such as a cone having a central region of the retina as a base and the centre of ocular rotation as a vertex). If the convergent arc has a radius of convergence greater than the radius of the sphere, the convergent arc will be outside the eye and in front of the pupil.

The term “angle of rotation of the eye” may also be defined as an orientation of the eye (or the pupil), an angle of rotation of the pupil or a position of the pupil. An angle of rotation may be defined relative to a default axis corresponding to an orientation of the pupil when the eye is deemed to be at rest.

In certain aspects herein, the optical system moves the at least one convergent point based on the angle of rotation of the eye. This may be done, for example, to cause the light to converge on a point that coincides substantially with the centre of the pupil of the eye. This may be called a dynamic eye-box, as the convergent point(s) is/are dynamically moved with the rotation of the eye.

In certain aspects herein, one or more steering portion may be provided, to move at least one element of the projection portion and the focusing portion. The (or each) steering portion may comprise electro-mechanical means such as actuators, motors, etc. which are configured to move element(s) of the projection portion, of the focusing portion, or both.

In certain aspects herein, the (or each) steering portion may comprise at least one optical element. The optical element(s) of the steering portion may be placed along the optical path of the light between the projection portion and the focusing portion. The optical element(s) of the steering portion may be movable to change the optical path of the light towards the focusing portion, thus causing the movement of the convergent point(s).

In certain aspects herein, at least one optical element may have a controllable phase modulation, which may be, for example, a phase or amplitude Spatial Light Modulator, SLM, a lens with controllable phase modulation, etc.

In certain aspects herein, the at least one convergent point is located on a convergent surface. In other words, the optical system may move the convergent point along two dimensions on the convergent surface, or the optical system may be configured to converge the light on convergent point(s) that are distributed along two dimensions on the convergent surface. The two dimensions would be understood to be distinct (e.g. orthogonal) dimensions.

In certain aspects herein, a plurality of light each encoding a respective portion of an image is caused to converge on a corresponding one of a plurality of convergent points. These convergent points may be spaced apart (or distributed) along the convergent arc or along the convergent surface at regular intervals, or the distance between adjacent convergent points may vary along the arc or surface, for example by providing a greater density at a portion of the arc that corresponds to the angle of rotation when the eye is at rest. In some cases, adjacent convergent points may be sufficiently close to each other such that the light converging at two or more convergent points enter the eye simultaneously, projecting different portions of the image onto different parts of the retina (which may be overlapping).

In certain aspects herein, one or more eye-tracker to track one or both eyes of the user may be used. Each eye tracker may be a camera-based tracker, a tracker using physiological sensors (e.g. based on ECG signals), or other sensing methods such as a LIDAR, which may track the pupil or the protrusion formed by the cornea. Each tracker may be a camera-based tracker(s), in which case the camera(s) may be a camera capturing images in a visible wavelength range (e.g. a red-green-blue, RGB, camera), or in an infrared, IR, range (e.g. an IR camera, a near-IR camera). Each tracker may comprise at least one optical source, which may be an IR light, or a visible (e.g. white) light that is off-centred not to be detected by the eye, or with a luminosity below a threshold to avoid or reduce any effect on the image projected into the eye.

In certain aspects herein, the optical system may project images into both eyes of the user, for example by comprising separate portions (e.g. separate projection portions, focusing portions, steering portions and/or eye-trackers) for each eye, where the portion(s) for each eye may be separately controlled.

In certain aspects herein, a display and a focusing element may be used. For example this may a self-emissive display emitting light rays. The display (e.g. self-emissive display) may emit collimated light rays or may include collimating optics to collimate the light rays, or the light rays emitted by the display may be divergent, for example if the focusing element is configured, due to its position and/or focal length, to receive the divergent light rays and converge them towards the focusing portion. The spatial filter may be, for example a pin-hole (or Fourier) filter.

In certain aspects herein, a coherent light source may be used. The coherent light source may be any light source emitting light with at least a predetermined level of coherence, for example a coherence sufficient to be modulated by a phase modulator (e.g. an SLM such as a device comprising an array of steerable micromirrors such as a Digital Light Processing, DLP, or other types of Digital Micromirror Device, DMD, etc). The coherent light source may comprise a laser.

In cases where the coherent light source is a laser, the laser may comprise one or more laser diodes, where each laser diode may be configured to emit light at a given wavelength (e.g. diodes emitting at a red, green, and blue wavelengths, at an infrared wavelength. Preferably, the laser may comprise a plurality of diodes (e.g. at least a red, green, and blue diode) to emit light substantially across the visible spectrum.

In certain aspects herein, a light-field display may be used to project light encoding elemental images. Each elemental image of the light field may have an associated perceived depth (e.g. corresponding to a distance between the retina and a focal point where light rays associated with the elemental image converge), and the light for each elemental image may be projected onto a different portion of the retina. The part formed by each elemental image may overlap at least one part formed by an adjacent elemental image.

In certain aspects herein, the optical system may comprise a foveation portion and a projection portion with a light-field display. In such cases, the light-field display may be configured to project light encoding different elemental images for the foveal mode and for the peripheral mode.

In certain aspects herein, the optical system may comprise a foveation portion and the projection portion comprising a phase modulator to project light encoding a holographic image. In such cases, the phase modulator may project light encoding different holographic images for the foveal mode and for the peripheral mode.

In certain aspects herein, at least one switchable optical element may be used. In such cases, each switchable optical element may be, for example, a converging or diverging element configured to change the angular size of the light passing through. For example, each switchable optical element may be a converging/diverging lens, a mirror, Holographic Polymer Dispersed Liquid Crystal, HPDLC, layer, an Alvarez lens, or a polarizing switchable lens such as a polarizing volume grating, etc.

In certain aspects herein, a switchable optical element (hereinafter also referred to as SOE) may be defined as being switch to a first state or to a second state. The switchable optical element may have different focal length in the second state than in the first state.

For example, the first state may correspond to a state where the SOE allows the light to pass substantially without altering an angular size of the light whereas in the second state, the SOE may change the angular size of the light (e.g. by causing incident light rays to converge or diverge, or by collimating incident light rays that are convergent/divergent). In other words, in one of the states (e.g. the first state), the SOE may correspond to a neutral lens.

In another example, in both the first state and the second state, the SOE may change the angular size of incident light rays.

In certain aspects herein, the SOE may be caused to switch to a first state or a second state by controlling an electrical signal received by the SOE (e.g. a control voltage). The SOE may, upon receiving the electrical signal, switch to the second state, and, when the electrical signal is no longer received, switch to the first state (or vice-versa). Accordingly, the first state and the second state may be defined as “off” and “on” states, or “default” and “activated” states.

As used herein, the term “central region of the retina” may mean, for example, a macula of the retina, and preferably one of a perifovea, a parafovea, a fovea, a foveal avascular zone, a foveola, and an umbo of the retina.

As used herein, the term “eye box” may mean the area in front of a projection device where a user's eye can be placed to view the images displayed by the projection device without distortion or part of the displayed image missing.

As used herein, the term “field of view” may mean the angular extent of an image displayed to a user's eye.

### BRIEF DESCRIPTION OF THE DRAWINGS

FIGS. 1A and 1B show schematic views of a conventional projection device;

FIGS. 2A and 2B show schematic views of another conventional projection device;

FIGS. 3A and 3B show schematic views of a projection device in example embodiments;

FIG. 4 shows a schematic diagram of a projection device in example embodiments;

FIG. 5 shows a computing unit for controlling an optical system in example embodiments;

FIGS. 6A and 6B show schematic views of optical systems in example embodiments;

FIGS. 7A and 7B show schematic views of optical systems in example embodiments;

FIGS. 8A and 8B show schematic views of optical systems in example embodiments;

FIGS. 9A and 9B show schematic views of optical systems in example embodiments;

FIGS. 10A and 10B show schematic views of optical systems in example embodiments;

FIGS. 11A and 11B show schematic views of optical systems in example embodiments;

FIGS. 12A and 12B show schematic views of optical systems in example embodiments;

FIGS. 13A and 13B show schematic views of optical systems using a waveguide in example embodiments;

FIG. 14A shows a schematic view of a peripheral image being projected by optical systems in example embodiments;

FIG. 14B shows a schematic view of a foveal image being projected by optical systems in example embodiments;

FIGS. 14C to 14D show schematic views of foveal and peripheral images being projected by optical systems in example embodiments;

FIGS. 15A and 15B show schematic views of optical systems using a foveation portion in a peripheral mode and in a foveal mode, respectively, in example embodiments;

FIGS. 16A and 16B show schematic views of optical systems using a foveation portion in a foveal mode and in a peripheral mode, respectively, in example embodiments;

FIGS. 17A and 17B show schematic views of optical systems using a foveation portion in a foveal mode and in a peripheral mode, respectively, in example embodiments;

FIGS. 18A and 18B show schematic views of optical systems using a foveation portion in a foveal mode and in a peripheral mode, respectively, in example embodiments;

FIGS. 19A and 19B show schematic views of optical systems using a foveation portion in a peripheral mode and in a foveal mode, respectively, in example embodiments;

FIGS. 20A and 20B show schematic views of optical systems using a foveation portion in a peripheral mode and in a foveal mode, respectively, in example embodiments;

FIGS. 21A and 21B show schematic views of optical systems using a foveation portion in a peripheral mode and in a foveal mode, respectively, in example embodiments;

FIGS. 22A and 22B show schematic views of optical systems using a foveation portion in a foveal mode and in a peripheral mode, respectively, in example embodiments;

FIGS. 23A and 23B show schematic views of optical systems using a foveation portion in a peripheral mode and in a foveal mode, respectively, in example embodiments;

FIG. 24A shows a schematic view of optical systems using a light-field display, in example embodiments;

FIGS. 25A to 25E show schematic views of elemental images projected by optical systems using a light-field display in example embodiments.

### DETAILED DESCRIPTION

For simplicity, the following description will refer to the eye rotating about a rotation axis in a two-dimensional space, which would be understood to be an axis normal to the plane shown in the figures, and near the centre of the sphere representing the eye. Accordingly the optical systems described herein may adapt the image projected into the eye for a movement of the eye along one axis of rotation of the eye (for example a rotation about a vertical axis as the eye moves sideways/left and right, or a rotation about a horizontal axis as the eye moves upwards and downwards)

However, it would be understood that the optical systems described herein may adapt the image substantially for a movement of the eye along both axis of rotation of the eye (e.g. both the vertical axis and the horizontal axis described above), such that the image may be adapted to any movement of the eye. In that case, the angle of rotation of the eye may be considered as an angle along two rotation axes of the eye. Thus, the optical systems described herein may therefore be configured to cause the light to converge on at least one convergent point that are located on an arcuate surface comprising the convergent arc. In other words, this “convergent surface” may be defined by two convergent arcs in two distinct dimensions, each arc having a centre of curvature substantially coincident with the ocular rotation axis and each arc being on or near the pupil of the eye. Thus, the defined surface may be substantially parallel to an outer surface of the cornea, the iris, or the lens of the eye.

As explained below, elements of the optical system (e.g. the eye tracker, the computing unit, the projection portion etc.) may be communicatively connected to each other. The connection may be establishing one or more suitable communication link. Each communication link may be, for example, a wireless communication link, for example Wi-Fi, Bluetooth or Bluetooth Low Energy (BLE), Near Field Communication (NFC) or a wired communication link such as a serial communication link (for example I²C, SPI, RS232, RS422, RS432), a communication bus, etc. Each communication link may not be permanent.

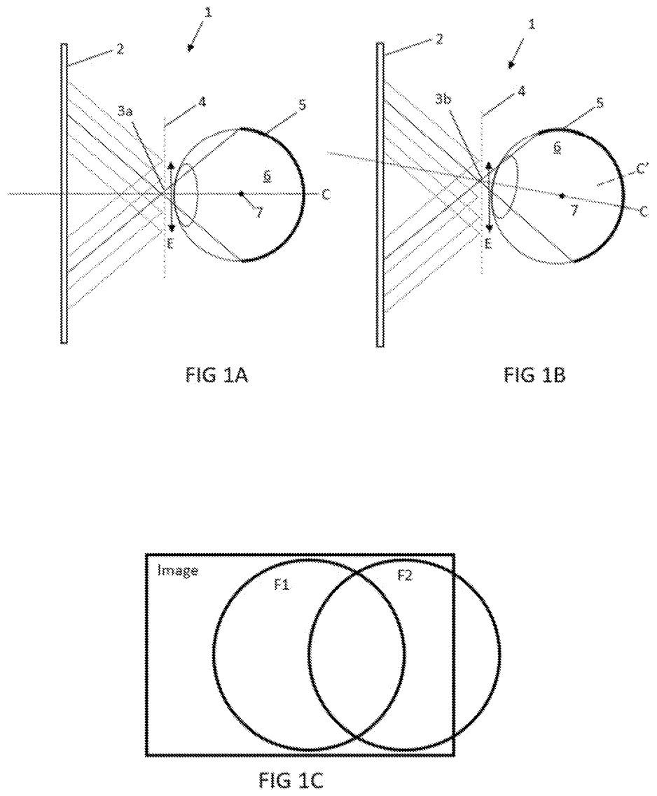

FIGS. 1A and 1B show schematic views of a conventional projection device 1 for projecting images into the eye. The projection device 1 may otherwise be known as a near-eye display. The projection device 1 comprises a projection portion (not shown) which is configured to generate and modulate light such that the projected light encodes an image in an optical system 2. The optical system 2 comprises one or more optical elements configured to converge the projected light to the eye 6 such that an image 5 is formed on the retina of the eye 6. In FIG. 1A, the device 1 is shown as converging the light to a first convergent point 3a, which lies on convergent plane 4 just outside of the eye (although in some configurations the convergent plane 4 lies on the surface or inside the eye). The projection device 1 further comprises an eye tracker (not shown) which tracks movement of the eye 6 about the rotation axis 7 of the eye 6.

FIG. 1B shows the device 1 in a second configuration. The eye 6 is rotated about the axis 7 to a new position. The eye tracker measures the position of the eye 6 and the optical system 2 dynamically changes to converge the light to a second convergent point 3b which is displaced along the convergent plane 4 from the first convergent point 3a. The position of the convergent point is selected to correspond to the position of the pupil of the eye 6, so that the light enters the eye and the image 5 is formed on the retina. The eye box E of the device 1 is defined by the maximum displacement positions of the convergent points 3 that the device 1 is able to produce.

The above-described system provides a dynamic eye box, in which only the portion of the eye box which enters the pupil is projected into the eye. This saves energy for the projection device 1 as light is not projected to points on the convergent plane which would not enter the pupil of the eye 6. However, as can be seen from the configuration shown in FIG. 1B, when the eye rotates away from the centre of the convergent plane 4, the image 5 is shifted laterally on the retina such that the centre C′ of the image 5 does not align with the centre C of the retina. Accordingly, the viewer of the projection device 1 perceives the edge of the eye-box (or the edge of the FOV) and is able to move the eye 6 so that the retina is centred on the edge of the eye-box. The resulting effect is that the user perceives the projected virtual scene as being displayed through a window with edges. This is illustrated in FIG. 1C which shows the image of the projection device 1 perceived by the user. When the user's eye 6 is centred on the eye box, the user's central vision indicated by F1 is contained within the edges of the image so that the user is not aware of any edge. When the user's eye 6 moves away to the periphery of the eye box, the user's central vision indicated by F1 is such that the edge of the image is perceived, so that the user generally perceives that the image is being viewed through a fixed window (also referred to as a window effect herein).

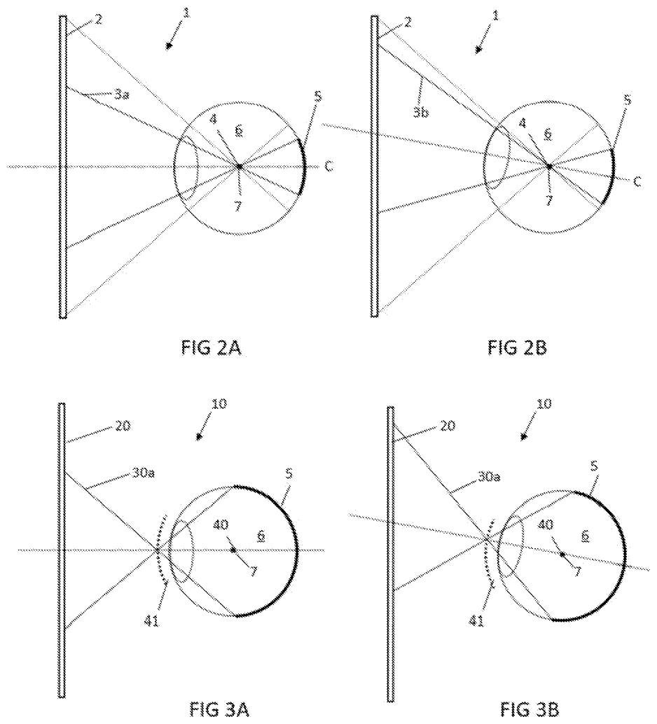

In order to overcome this problem, a projection device 1 such as that shown in FIGS. 2A and 2B may be provided. The projection device 1 comprises a projection portion (not shown) which is configured to project light encoding an image in an optical system 2. The optical system 2 comprises one or more optical elements configured to converge the projected light to the eye 6 such that an image 5 is formed on the retina of the eye 6. Unlike the device shown in FIG. 1A, the device 1 converges the light to a convergent point on or proximal the rotation axis 7 of the eye 6. The projection device 1 further comprises an eye tracker (not shown) which tracks movement of the eye 6 about the rotation axis 7 of the eye 6. FIG. 2B shows the device 1 in a second configuration. The eye 6 is rotated about the axis 7 to a new position shown in FIG. 2B. The eye tracker measures the position of the eye 6 and the optical system 2 dynamically changes to rotate the projected light to match the rotation of the eye 6 about the axis 7, so that the light enters the eye and the image 5 is formed on the retina. The eye box E of the device 1 is defined by the maximum rotational positions of the projected light that the device 1 is able to produce.

Unlike the system shown in FIGS. 1A and 1B, the image 5 remains centred on the retina so that the window effect is removed. However, the image 5 formed on the retina is limited by the optical aperture of the pupil and thus reduced in size compared to the device shown in FIGS. 1A and 1B, limiting the field of view which is viewed by the user at a given time.

FIGS. 3A and 3B show a schematic view of a projection device 10 according to one or more embodiments. The projection device 10 comprises a projection portion (not shown) which is configured to project light encoding an image in an optical system 20. The optical system 20 comprises one or more optical elements configured to converge the projected light to the eye 6 such that an image 5 is formed on the retina of the eye 6. Unlike the devices shown in FIGS. 1A, 1B, 2A and 2B, the device 10 converges the light to a point on a convergent arc 41 forward of the rotation axis 7 of the eye 6 (i.e. the arc is located between the rotation axis 7 and the optical system 20), and more specifically at or proximal to the pupil of the eye 6 (inside or outside), whilst the image is still rotated about the rotation axis 40 which is proximal to or coincident with the rotation axis 7 of the eye. In other words, the distance between the convergent point of the light and the rotation axis 7 of the eye (and the image) is selected to be approximately equal to the distance between the pupil or the lens of the eye 6 and the rotation axis 7. For example, a distance between the convergent point and the rotation axis 7 (which may correspond to a radius of curvature of the convergent arc) may be between 1 cm and 2 cm.

Projection device 10 may further comprises an eye tracker (not shown) which tracks movement of the eye 6 about the rotation axis 7 of the eye 6. FIG. 3B shows the device 10 in a second configuration. The eye 6 is rotated about the axis 7 to a new position shown in FIG. 3B. The eye tracker measures the position of the eye 6 and the optical system 20 dynamically changes to rotate the image 5 to match the rotation of the eye 6 about the axis 7, so that the light enters the eye and the image 5 is formed centred on the retina. The eye box E of the device 10 may correspond to an area defined by the maximum rotational positions of the projected light that the device 10 is able to produce.

Unlike the device 1 shown in FIGS. 2A and 2B, the device 10 allows for a wider field of view due to the convergent point of the projected light being proximal to the pupil, whilst still having the image centred on the retina of the eye 6 (i.e. centred on, or proximal to, a central region of the retina) in order to avoid the window effect. Preferably, the image 5 may be centred on, or proximal to, a macula of the retina. More preferably, the image 5 is centred on, or proximal to, a region forming the macula such as the perifovea, the parafovea, the fovea, the foveal avascular zone, the foveola, or the umbo.

In a three-dimensional space, the rotation axis 40 may be, for example, a vertical axis allowing the image 5 to remain centred on a central region of the retina during a lateral movement of the eye, or a horizontal axis allowing the image 5 to remain centred on a central region of the retina when the eye is moved upwards or downwards.

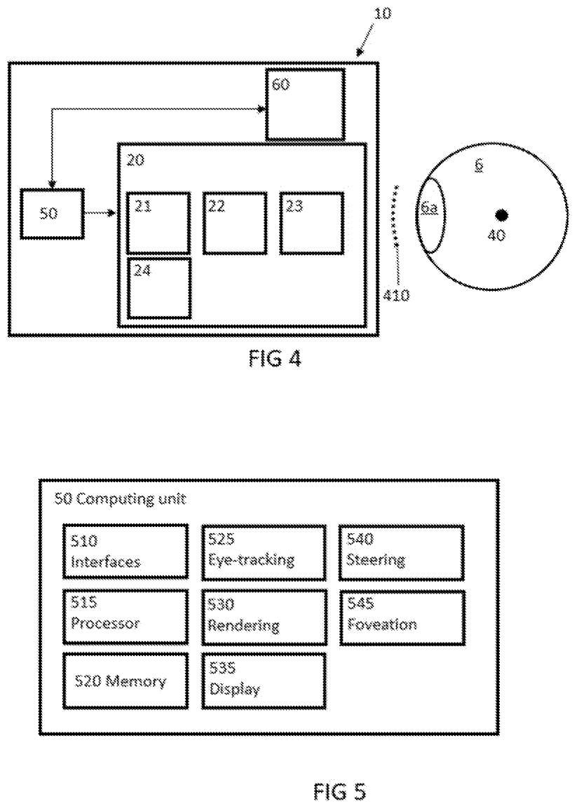

FIG. 4 shows a projection device 10 according to one or more embodiments. The projection device 10 comprises an eye-tracker 60, a computing unit 50 and an optical system 20. The projection device may further comprise any suitable power source such as a battery or other AC or DC power source, and/or may comprise a power connector for connecting to an external AC or DC power source. The eye-tracker 60 may be any suitable eye-tracker which is configured to track the location of a user's pupil. The eye-tracker 60 is communicably connected to the computing unit 50 (for example via communication wire or via a wireless communication link) and is configured to output a value to the computing unit 50 which is indicative of the location of the pupil 6a of the user's eye 6. The computing unit 50 is configured to render a scene (i.e. a 2D or 3D image or video, which may comprise one or more virtual elements), and is configured to render scene based on the position of the eye 6. More specifically, the computing unit 50 is configured to calculate in which direction within the scene the pupil 6a is pointing, and to render that part of the scene.

The eye-tracking element 60 may, for example, comprise an IR (infrared) and/or RGB camera and an IR source for the eye. The IR source illuminates the eye to be able to track the eye in low-light conditions, without being seen by the user (as the frequency of the light is outside of the human visual spectrum). The eye-tracking element 60 may be mounted to the device 100 separately to the optical system 20 or may utilize one or more of the optical elements within the optical system 20 to direct the illumination light to the eye 6 and to reflect reflected light back to the eye-tracking element 60. In some cases where both eyes are to be tracked, a same eye-tracking element 60 may be configured to track each eye, or separate eye-tracking elements may each track a respective eye.

The projection device further comprises an optical system 20. The optical system 20 comprises a projection portion 21 configured to project light which encodes an image of the rendered scene generated by the computing unit 50. The optical system further comprises a steering portion 22 which is configured to steer the light rays emitted from the optical system 20 about the axis of rotation 40 (see FIGS. 3A and 3B for reference) based on the location of the pupil 6a, as instructed by the computing unit 50 (or alternatively based on direct communication with the eye-tracker 60). Finally, the optical system comprises a focusing portion 23 which is configured to converge the light rays encoding the image to a point on the convergent arc 41. The projection portion 21, steering portion 22 and focusing portion 23 may be formed as separate optical elements or two or more of the elements may be comprised in a single optical element which performs the two or more of the functions of elements 21, 22 and 23. There may be provided separate projection portions 21, steering elements 22 and focusing elements 23 for each eye, or the same elements 21, 22 and/or 23 may be used to project images into both eyes (for example sequentially in time, or spatially). In such cases, the image projected into each eye may differ from each other. For example with an offset to provide a stereoscopic image, or a portion (e.g. half) of a larger image may be projected in each eye.

The computing unit 50 may control all of the elements or separate computing units may be provided to control different optical components for each eye (i.e. the projecting device comprises a first eye-tracker, computing unit and/or optical system for the left eye, and a second eye-tracker, computing unit and/or optical system for the right eye).

In some embodiments, the projection portion 21 may comprise a light generating element and a light modulating element which modulates the light generated by the light generating element to encode the image.

The focusing element 23 may be an optical combiner which redirects and converges the light such that the image is projected to the eye while letting the environment light pass through, so that the virtual image formed by the optical system 20 is superimposed onto the real-world environment (augmented reality). In embodiments where the projection device is a pair of smart glasses, the optical combiner may be formed as part of the lens or lenses of the smart glasses. In other embodiments, the focusing element 23 may be provided in combination with opaque lenses such that light from the environment does not combine with the image, so that an entirely virtual view is given (virtual reality).

In some embodiments, the focusing element 23 or optical combiner may be a curved transparent reflector or off-axis concave (or parabolic) mirror. The projection portion 21 and steering element 22 may be mounted in or on the arm of the glasses, and the light may be projected through the air towards the glasses lens, which is reflected and converged to the eye by the concave reflector on the lens, which acts as a converging lens.

In some embodiments, the focusing element 23 or optical combiner may comprise one or more flat or curved holographic optical element (HOE), each of which may be a photopolymer formed on a glass substrate. The HOE can be recorded to act as an off-axis concave mirror such that it behaves like a curved reflector. The HOE can be manufactured to have the same optical properties as a curved reflector whilst being much thinner.

In some embodiments, the focusing element 23 or optical combiner may comprise one or more Holographic Polymer Dispersed Liquid Crystal (HPDLC) or Switchable Bragg Grating, each of which act as a HOE that can be switched on and off (when switched off the HPDLC or Bragg Grating is transparent, and may let the light through substantially without altering an angular size of the light).

When a HOE or single HPDLC is used, there may be a lower tolerance for incident rays that differ in incident angle to the recorded angle. Accordingly, this may restrict the eye box of the projection device. Accordingly, in some embodiments, the optical combiner may comprise multiple HPDLC layers recorded for different steering angles, and the computing unit 50 may be configured to switch on the HPDLC that corresponds to the desired steering angle so that the light is correctly converged to the pupil.

In some embodiments, the focusing element 23 or optical combiner may comprise a waveguide, in which the light is projected through the waveguide and converged to the eye by means of Total Internal Reflection (TIR). It will be appreciated than many suitable waveguide configurations could be used. In some embodiments, a holographic waveguide comprising an incoupler and an outcoupler is used.

In some embodiments, at least one of the projection portion 21 and the focusing portion 23 may be movable by the steering potion 22 so as to steer the light about the axis of rotation 40. In some embodiments, the projection portion 21 may be movable to cause the convergent point to move along one of the dimensions of the convergent surface, and the focusing portion may be movable to cause the convergent point to move alone the other one of the dimensions of the convergent surface. Accordingly, by moving both the projection portion 21 and the focusing portion 23, the convergent point may be moved in accordance with any movement the eye makes.

In some embodiments, the eye-tracker 60 may be omitted. Instead, the projection portion 21 may be configured to project light encoding a plurality of portions of the image 5, and the focusing portion 23 may be configured to converge each light on a corresponding one of a plurality of convergent points that are located on the convergent arc (or the convergent surface). The location of each convergent point corresponds to a respective angle of rotation of the eye 6 about the ocular rotation axis 4. Accordingly, when the eye is rotated at an angle corresponding to one of the convergent point, the light converging at that convergent point enters the eye and forms an image centred on the retina of the eye. The light converging on adjacent convergent points may encode adjacent portions of the image, so the eye can rotate from an angle corresponding to one convergent point to the angle corresponding to the adjacent convergent point without causing a visible transition in the image formed on the retina.

In some embodiments, the eye-tracker 60 may comprise a light source. The light source may be configured so as not to be detectable by the eye. Accordingly, the light source may be prevented from affecting the image that is to be projected into the eye. By way of non-limiting examples, the light source may be configured such that light rays emitted by the light source do not enter the eye due to a position and/or orientation of the light source, or light rays from the light source are not projected onto the retina, or are not visible (i.e. detectable by the cells of the retina).

In some embodiments, the projection device is to be held or worn by the user. By way of non-limiting examples, the projection device may comprise a headset to be mounted on a head of the user, with elements of the optical system being provided near and in front of the user's eye (or eyes).

In some embodiments, the projection device comprises a housing that stores element(s) of the optical system. The housing may be, for example, located on a headset of the projection device. Accordingly, the element(s) stored in the housing may be protected from the environment, for example by avoiding undesired light from the environment to affecting the light encoding the image to be projected.

FIG. 5 shows a computing unit 50 for controlling a projection device according to one or more embodiments. The computing unit 50 comprises one or more communication interfaces 510 for communicating with the eye-tracker 60, components of the optical system 20. The communication interfaces may allow the computing unit 50 to communicate with other computing units external to the projection device 10, for example to exchange data relating to the images to be projected. Each communication interface may use any suitable communication link as described herein.

The computing unit 50 further comprises a processor 515. The processor 515 may comprise one or more processing units, such as a microprocessor, GPU, CPU, multi-core processor or similar computer processing units.

The computing unit 50 further comprises a memory 520. The memory 520 may be any suitable storage medium, including without limitation, an optical disc, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data. The memory 520 may store two-dimensional or three-dimensional image data and any other data which is to be displayed to the user, and may store data received from the eye-tracker 60 and/or components of the optical system 20.

The computing unit 50 may further comprise an eye-tracking module 525, a rendering module 530, a display module 535 and a steering module 540. All of the modules of the computing unit 50 may be implemented in hardware, software, or a combination of the two. For example, the modules may be stored as software in the memory 520. The modules may comprise any suitable sequence of instructions stored in the computing unit 50 configured to perform the methods disclosed herein.

In operation, the eye-tracker 60 tracks the location of the user's pupil (or pupils) and outputs a value indicative of the angle of rotation of the pupil, which is received by interface 510. The eye-tracking module 525 may convert this data into co-ordinates in a pre-determined co-ordinate system which describes the direction in which the pupil(s) are pointing. The rendering module 530 may then receive the co-ordinates describing the direction in which the pupil(s) are pointing, receive image data from the memory 520, and render a 2D or 3D image to be displayed to the pupil(s). The rendering module 530 may render different images for each pupil, taking into account parallax, so that the user perceives a 3D environment. The rendered image data are sent to the display module 535, which generates instructions to the projection portion 21 such that the projection portion 21 projects light which encodes the rendered image. The steering module 540 calculates the steering angle of the steering element 22 which corresponds to the direction of the pupil(s), and instructs the steering element 22 to steering the image to the correct steering angle. The rendered image is then converged by the focusing element 23 and formed on the retina(s) of the user's eye(s). The value output by the eye-tracker 60 may specify an angle of rotation of the pupil (e.g. the output of the eye-tracker 60 may include an angle value in degree or radians), or the output of the eye-tracker may be an image of the eye (e.g. from a camera) or a sensor value (e.g. from an ECG sensor), and the eye-tracking module may determine the angle of rotation of the pupil based on the received image or sensor value.

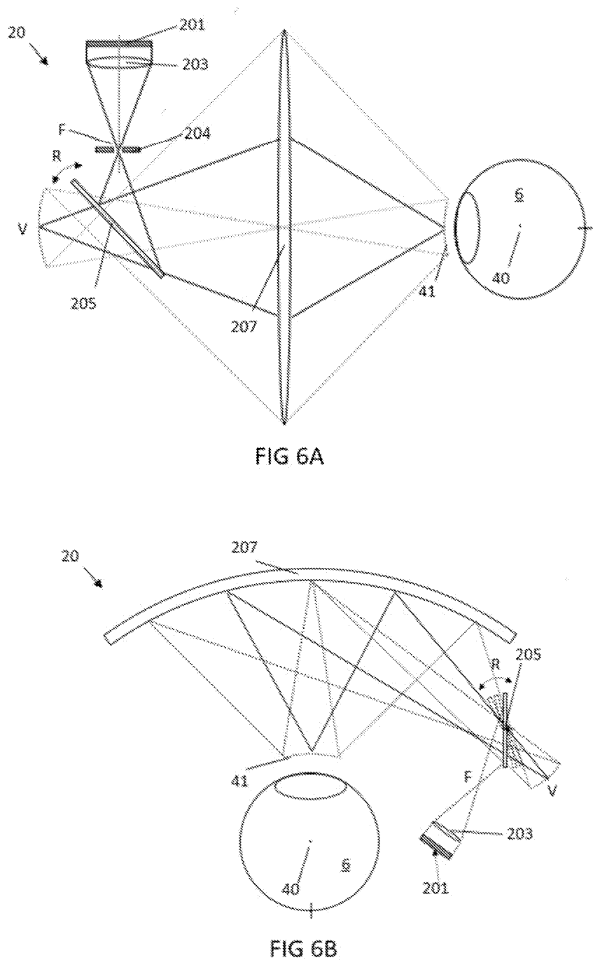

FIG. 6A shows a schematic view of an optical system 20 for a projection device according to one or more embodiments. The projection device comprises a self-emissive display 201, for example a micro-LED display, which emits the image to be displayed in collimated light rays (or a standard display may be used with collimating optics placed in front of the display). The device further comprises a focusing element 203 which converges the light rays. The device further comprises a steerable mirror 205, which may be for example a MEMS mirror (i.e. a mirror comprising a micro-electro-mechanical system, MEMS), which is placed at a position after the convergent point F of the focused light rays. The steerable mirror 205 reflects the light towards a focusing element 207 which converges the light to a convergent point on the arc 41. The image is formed on the retina of the eye 6. Steering the mirror 205 as indicated by the arrow R rotates the virtual image V of the convergent point F, which in turn translates the convergent point of the light rays along the arc 41. Accordingly, the mirror 205 can be steered to follow the position of the eye 6 so that the image projected onto the retina remains centred on the retina.

It is noted that whilst the focusing elements 203 and 207 are shown as transmissive lenses, they may instead be concave reflective mirrors with the same focal length, or HOEs. For example, FIG. 6B shows an alternative embodiment in which a curved mirror or HOE is used instead of the lens for focusing element 207, which may also be an optical combiner configured to allow light from the environment to pass through the mirror/HOE. If the coherence of the light rays is required, for example in order to use a HOE for components 203 or 207, a pinhole filter 204 (which may be called a spatial of Fourier filter) may be added to the optical system.

For the optical system 20 shown in FIGS. 6A and 6B, the display 201 and focusing element 203 may be considered as the projection portion 21, the steerable mirror 205 may be considered the steering element 22 and the focusing element 207 may be considered the focusing element 23 of FIG. 4 (and both elements 21 and 22 may be mounted in or on an arm of a pair of smart glasses where the element 23 may be integrated or coupled to the smart glasses lens).

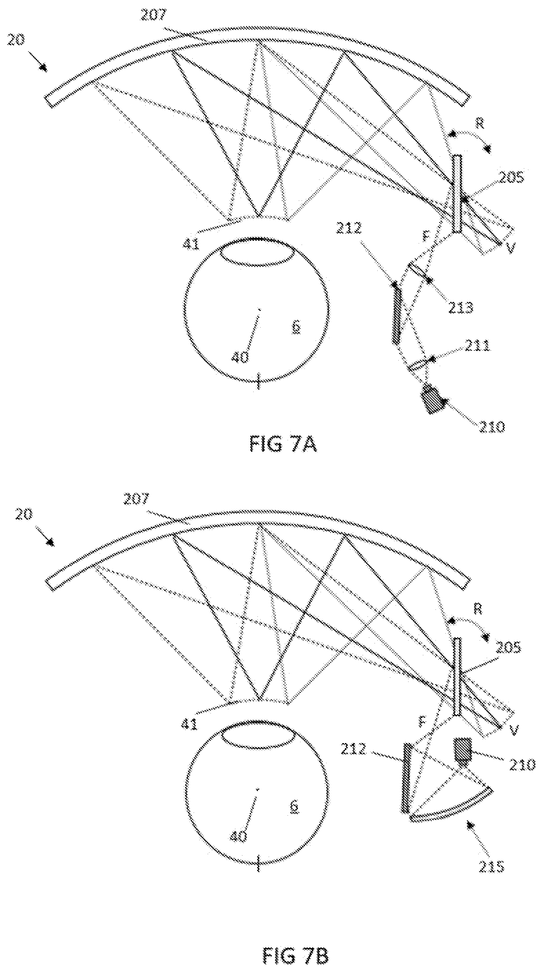

FIG. 7A shows a schematic view of an optical system 20 for a projection device according to one or more embodiments. The optical system comprises a laser 210, the laser comprising one or more laser diodes (e.g. separate RGB laser diodes or a single RGB diode) configured to emit light along red, green and blue light. It would be understood the laser may also emit IR light or light at other wavelengths in the visible spectrum. The light emitted by the laser 210 is collimated by a collimating element 211 (which is shown as a lens may alternatively be a concave reflective mirror or HOE as shown on FIG. 7B). The collimated laser light is incident on a phase or amplitude Spatial Light Modulator (SLM) 212, which modulates the light such that the image to be projected is encoded in the light transmitted by the SLM 212. Any suitable SLM may be used, such as transmissive or reflective amplitude and/or phase modulators based on Liquid Crystal (LC) or Liquid Crystal on Silicon (LCoS) or Digital Micromirror Device (DMD). It is noted that whilst the SLM 212 in FIG. 7A is shown as being a reflective SLM, alternatively a transmissive SLM may be used. The modulated light is then converged to a convergent point F by focusing element 213 (which is shown as a lens but may be a concave mirror or HOE) before it is incident on a steerable mirror 205, which may be any suitable steerable mirror such as a MEMS mirror. The light is reflected by the steerable mirror 205 towards focusing element 207 (curved reflector or HOE), which converges the light to a point on the convergent arc 41. In other embodiments, the focusing element 207 is a focusing lens, analogous to the embodiment shown in FIG. 6A. The image is projected onto the retina of the eye 6. When the steerable mirror 205 is steered, indicated by the arrow R, the virtual image V of the convergent point F is rotated about an arc, and the convergent point at the pupil of the eye 6 is shifted along the arc 41. Accordingly, the steerable mirror 205 is controllable to rotate the image projected onto the retina such that it remains centred on the retina. The collimating lens 211 and 213 may be replaced by a single focusing element 215 comprising a concave reflective mirror (or one or more lens), as shown in FIG. 7B. The focusing element 215 is configured to direct the laser light from the laser 210 to the SLM 212, such that the light is incident on the SLM 212 in a non-collimated manner and such that the light is converged to convergent point F in front of the steerable mirror 205. The SLM 212 modulates the non-collimated light such that the image is encoded into the light. The focusing element 215 may be also placed after the SLM 212, once the image has been encoded into the light.

For the optical system 20 shown in FIG. 7A, elements 210, 211, 212 and 213 may be considered as the projection portion 21, the steerable mirror 205 may be considered the steering element 22 and the focusing element 207 may be considered the focusing element 23 of FIG. 4 (and both elements 21 and 22 may be mounted in or on an arm of a pair of smart glasses). For the optical system 20 shown in FIG. 7B, elements 210, 215 and 212 may be considered as the projection portion 21, the steerable mirror 205 may be considered the steering element 22 and the focusing element 207 may be considered the focusing element 23 of FIG. 4 (and both elements 21 and 22 may be mounted in or on an arm of a pair of smart glasses).

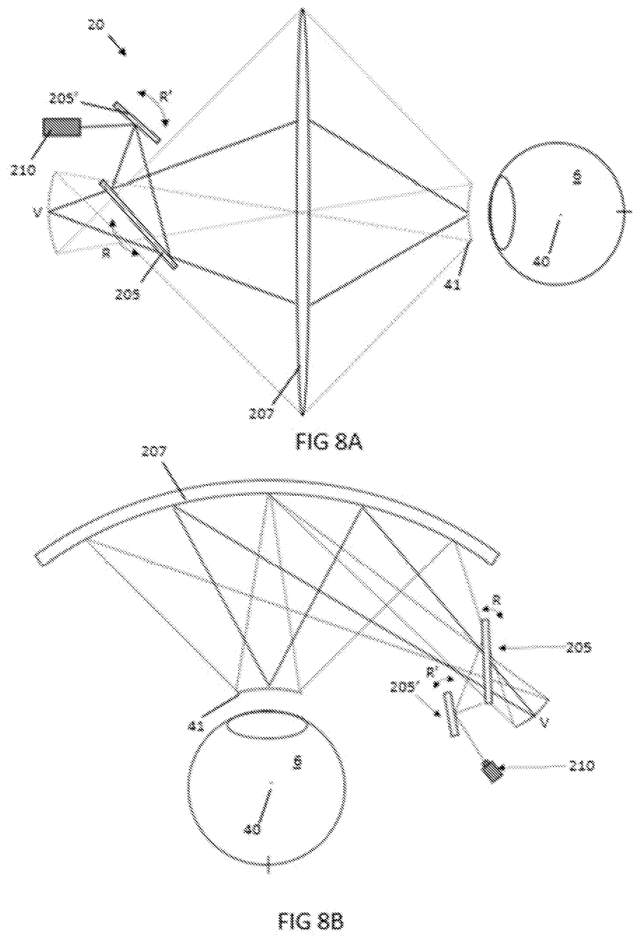

FIG. 8A shows a schematic view of an optical system 20 for a projection device according to one or more embodiments. The optical system comprises a laser 210, such as an RGB laser diode configured to emit red, green, and blue light. The laser 210 is configured to emit a laser beam to a steerable mirror 205′ (such as a MEMS mirror or the like). The steerable mirror 205′ is steerable (indicated by the arrow R′) and together the laser 210 and steerable mirror 205′ emit light which encodes the image to be viewed by the user (the selective emission of laser light from the laser 210 along with the selective position of the steerable mirror 205′ together provide the necessary generation and modulation of light in order to generate an image). The light is directed from the steerable mirror 205′ to steerable mirror 205 (any suitable mirror such as a MEMS mirror), which is configured to rotate (indicated by arrow R). The light reflected by the steerable mirror 205 corresponds to a virtual image V and is directed towards focusing element 207. In FIG. 8A, the focusing element 207 is a lens, whereas in other embodiments (as shown in FIG. 8B) the focusing element is a concave mirror, HOE, HPDLC or stacked HPDLC. The focusing element 207 converges the light to a convergent point on convergent arc 41 and an image is formed on the retina of the eye 6. Rotation of the steerable mirror 205 shifts the convergent point along the convergent arc 41 and rotates the projected image about axis 40 which is coincident or proximal to the axis of rotation of the eye, so that the image projected onto the retina remains centred on the retina as the user's eye rotates.

For the optical system 20 shown in FIG. 8A, elements 210 and 205′ may be considered as the projection portion 21, the steerable mirror 205 may be considered the steering element 22 and the focusing element 207 may be considered the focusing element 23 of FIG. 4 (and both elements 21 and 22 may be mounted in or on an arm of a pair of smart glasses).

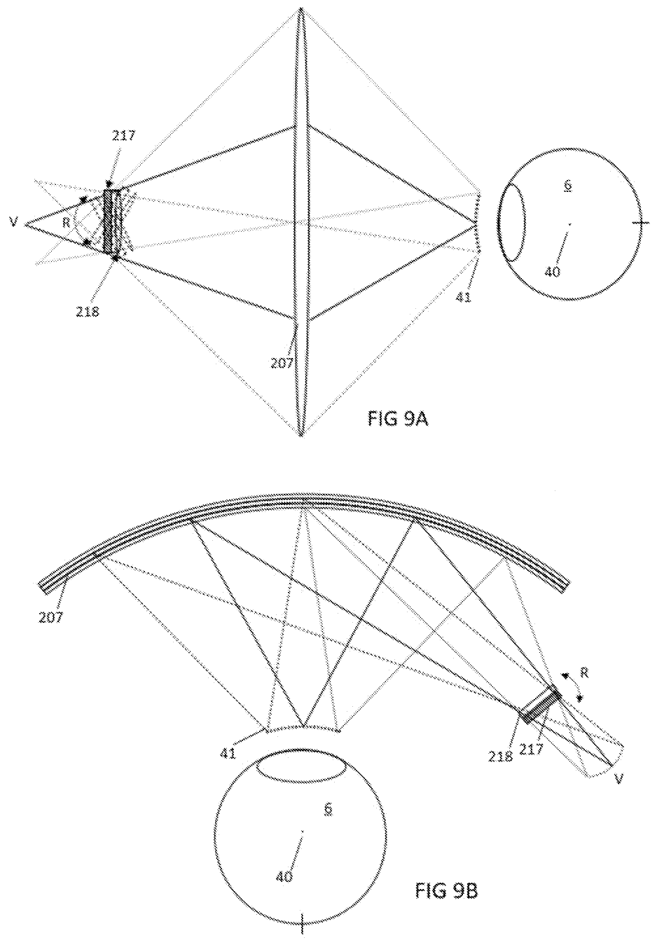

FIG. 9A shows a schematic view of an optical system 20 for a projection device according to one or more embodiments. The optical system 20 comprises a self-emissive display 217, for example a micro-LED display, which emits the image to be displayed in collimated light rays (or a standard display may be used with collimating optics placed in front of the display). The optical system further comprises a diverging element 218 which is configured to form a virtual image V of the convergent arc 41. Whilst the diverging element 218 is illustrated as a diverging lens, in other embodiments a convex mirror, HOE or HPDLC may be used which have the same optical properties as the diverging lens. The self-emissive display 217 and the diverging element 218 are mounted to a steerable element (not shown) such as a MEMS, such that the components are steerable by rotation, the direction of rotation indicated by arrow R. The light emitted by the diverging element is directed towards the focusing element 207, which is shown as a focusing lens, which converges the light to a convergent point on the arc 41, and the image is projected onto the retina of the eye 6. The display 217 and diverging element 218 are rotatable such that the convergent point moves to a point on the convergent arc which corresponds to the position of the eye 6. Accordingly, the image remains centred on the retina of the eye 6 as it moves. The display 217 and diverging element 2018 can be integrated in a single self-emissive display that emits diverging light.

In an alternative embodiment, the self-emissive display 217 may comprise a laser configured to illuminate a light modulating element, such as a spatial light modulator (SLM) or DLP, with divergent light. The divergent light is transmitted or reflected to the focusing element 207. The display 217 comprising the laser and light modulator are mounted to a steerable element such as a MEMS, such that the projected image follows the position of the eye and remains centred on the retina. In the embodiments where a laser configured to emit divergent light is used, the diverging element 218 is not required as the laser already emits a diverging beam.

In some embodiments, the focusing lens of focusing element 207 may instead be a concave reflective mirror, HOE, HPDLC or HPDLC stack which has the same optical properties as the focusing lens, as illustrated in FIG. 9B.

In the embodiments described with reference to FIGS. 9A and 9B, the display 217 and diverging element 218 (or SLM) mounted on the steerable element may be considered as both the projection portion 21 and the steering element 22, and the focusing element 207 may be considered the focusing element 23 of FIG. 4 (and both elements 21 and 22 may be mounted in or on an arm of a pair of smart glasses).

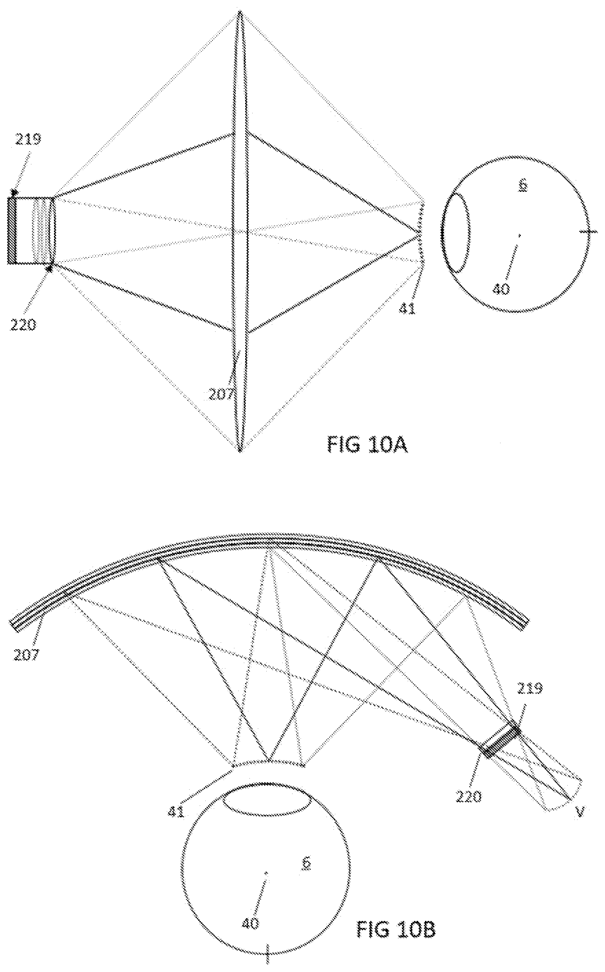

FIG. 10A shows a schematic view of an optical system 20 for a projection device according to one or more embodiments. The optical system 20 comprises a display 219. The display 219 may be a self-emissive display configured to emit coherent light, or a reflective or transmissive light modulating element such as a spatial light modulator (SLM) or DLP illuminated with substantially coherent light (for example coherent point light or collimated light). The coherent light emitted by display 219 is incident on a HPDLC stack 220 comprising a plurality of HPDLC layers. Each layer of the HPDLC is configured to act as a diverging lens, wherein each stack is recorded at a different angle. Accordingly, the angle at which the diverging beam is emitted depends upon which HPDLC layer (or combination thereof) is switched on. The diverging beam is directed towards focusing element 207, which in the illustrated embodiment is a focusing lens. The light is converged to a convergent point on convergent arc 41 and an image is projected onto the retina of the eye. The layers HPDLC stack 220 can be selectively switched on in different combinations in order to emit the divergent light to the focusing element 207 at different selectable angles. Depending on the selected angle, the light is converged to a different point on the convergent arc 41. Accordingly, the angle at which the image is projected onto the retina can be rotated about axis 40, such that the image projected onto the retina remains centred on the retina. Advantageously, this embodiment comprises no moving parts, simplifying the structure of the projection device.

In some embodiments, the light emitted by the display 219 may not be coherent and may instead be divergent. In such cases, the HPDLC stack 220 may modify the divergent light from the display 219 substantially as explained above.

The focusing element 207 may instead comprise a concave mirror, HOE or HPDLC or HPDLC stack having the same optical properties as the focusing lens, as illustrated in FIG. 10B.

In the embodiments shown in FIGS. 10A and 10B, the display 219 may be considered as the projection portion 21, the HPDLC stack 220 may be considered the steering element 22, and the focusing element 207 may be considered the focusing element 23 of FIG. 4 (and both elements 21 and 22 may be mounted in or on an arm of a pair of smart glasses).

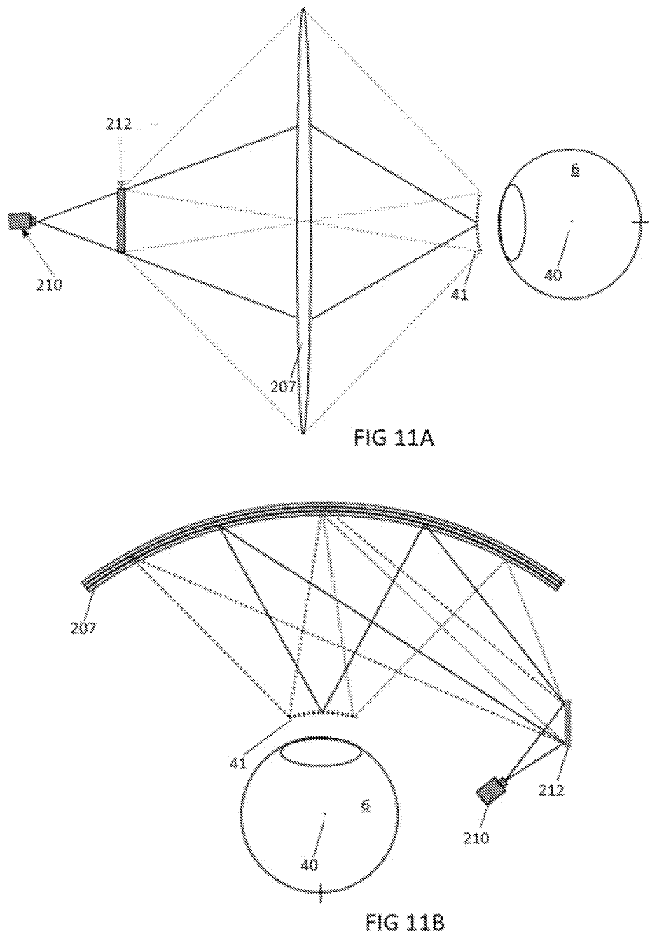

FIG. 11A shows a schematic view of an optical system 20 for a projection device according to one or more embodiments. The optical system 20 comprises a laser 210, for example an RGB laser, configured to emit divergent light to a phase modulator 212. The phase modulator may be, for example, a reflective or transmissive SLM or DLP. The phase modulator 212 is configured to spatially modulate the phase of the light (and may, optionally, also modulate the amplitude of the light) to encode an image. The phase modulator 212 is further configured to modulate the light to steer the beam in a given direction. The light is directed by the phase modulator 212 to the focusing element 207, which in the illustrated embodiment is a focusing lens. The light is converged by the focusing element 207 to a convergent point on convergent arc 41, and an image is projected onto the retina of the eye. The phase modulation of the light by phase modulator 212 can be selected in order to project the image in different directions such that the light is converged to different points along the convergent arc 41. Accordingly, the phase modulation can be controlled in order to project the image to a point on the convergent arc 41 which corresponds to the position of the eye 6, so that the projected image remains centred on the retina of the eye 6.

In some embodiments, the focusing element 207 may be a concave reflective mirror, HOE, HPDLC or HPDLC stack as shown in FIG. 11B. The phase modulator 212 may also be reflective as shown in FIG. 11B.

In the embodiments shown in FIGS. 11A and 11B, the laser 210 and phase modulator 212 may together be considered as the projection portion 21 and steering element 22, and the focusing element 207 may be considered the focusing element 23 of FIG. 4 (and both elements 21 and 22 may be mounted in or on an arm of a pair of smart glasses).

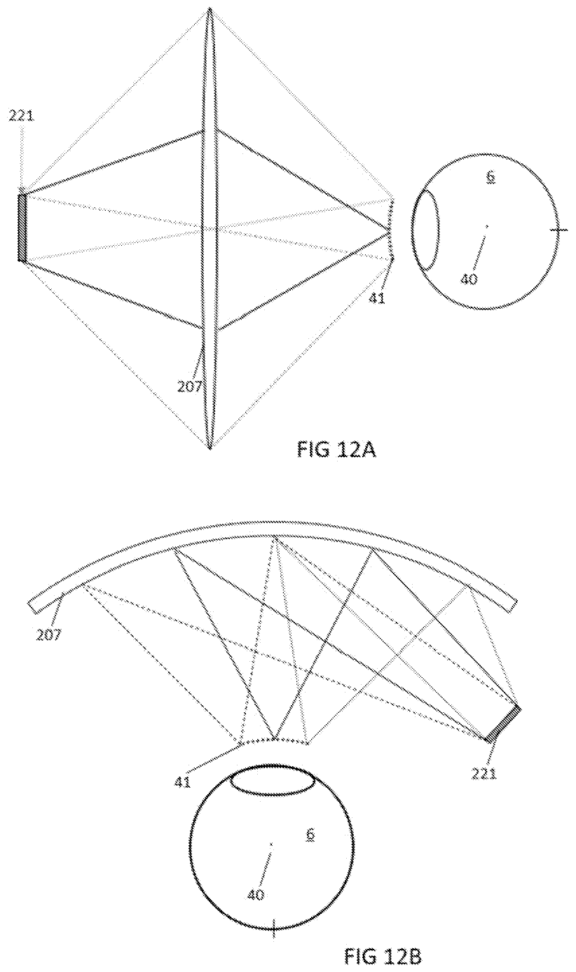

FIG. 12A shows a schematic view of an optical system 20 for a projection device according to one or more embodiments. The optical system 20 comprises a self-emissive steerable display 221 which is configured to both generate light and modulate the light. The display 221 is configured to emit light encoding an image to be projected onto the retina of the eye 6. The light is transmitted to focusing element 207, which in the illustrated embodiment is a focusing lens, which converges the light to a point on convergent arc 41, and the image is projected onto the retina of the eye 6. The display 221 is further configured to spatially modulate the phase of the light so that the image is projected in a particular direction and converged to a point along the convergent arc 41. The display 221 is therefore controllable to steer the projected light so that the convergent point is moved to a point on the convergent arc 41 which corresponds to the position of the eye, such that the projected image remains centred on the retina of the eye 6. In some embodiments, the focusing element 207 may be a concave reflective mirror, HOE, HPDLC or HPDLC stack as shown in FIG. 12B.

In the embodiments shown in FIGS. 12A and 12B, the self-emissive steerable display 221 may be considered as both the projection portion 21 and steering element 22, and the focusing element 207 may be considered the focusing element 23 of FIG. 4 (and both elements 21 and 22 may be mounted in or on an arm of a pair of smart glasses).

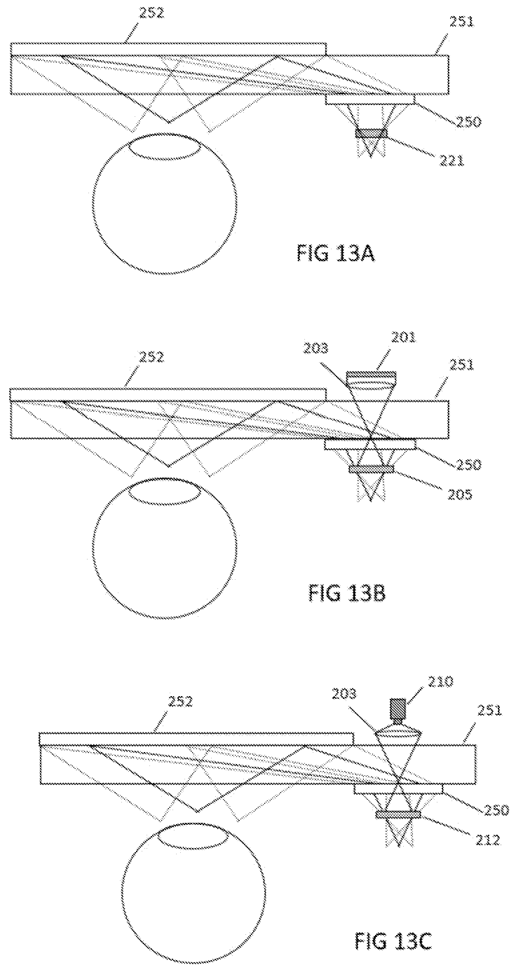

For any of the embodiments disclosed herein, it is noted that the projected light may be transmitted between optical components via a waveguide instead of via air. FIGS. 13A to 13C show schematic views of an optical system 20 which uses a waveguide.

Although the following exemplary embodiments are described with a single waveguide, this is not limiting, as any number of waveguides may be used. For example, in the embodiment shown in FIG. 7B, a first waveguide may be provided between the laser 210 and the focusing element 215, and a second waveguide may be provided after the rotatable mirror 205. Each waveguide may have a respective incoupler and outcoupler, and the outcoupler of the second waveguide may be used instead of the concave mirror 207 shown on FIG. 7B.

In the following exemplary embodiments, the outcoupler of the waveguide is located on the surface of the waveguide distal to the eye, and a TIR is used to reflect the light from the outcoupler of the waveguide and converge the light to the eye. However, these are non-limiting examples, as the outcoupler may instead be located on the surface of the waveguide proximal to the eye and converge the light to the eye by focusing the light.

In the embodiment shown in FIG. 13A, a self-emissive steerable display 221 generates light and modulate the light. The light is transmitted to an incoupler 250 of a waveguide 251. The light is guided through the waveguide 251 to the outcoupler 252 of the waveguide 252, which converges the light through the waveguide 251 to the eye by means of TIR.

In the embodiment shown in FIG. 13B, a self-emissive display 201 (either emitting collimated light rays or comprising collimating optics) emits the image to be displayed in collimated light rays. The collimated light rays pass through a focusing element 203 which converges the light rays through a waveguide 251. The light rays are then reflected on a steerable mirror 205 (e.g. a MEMS mirror). The light rays reflected off the steerable mirror 205 are transmitted to an incoupler 250 of the waveguide 251. As with the embodiment shown in FIG. 13A, the light rays from the incoupler 250 are guided through the waveguide 251 and converged by an outcoupler 252 to the eye by means of TIR.

In the embodiment shown in FIG. 13C, a coherent light source (e.g. a laser, LED emitting sufficiently coherent light, etc.) 210 emits light along the visual spectrum (e.g. at red, blue and green wavelengths), which is converged by a collimating element 211 (e.g. a lens as shown on FIG. 13C, or alternative a concave reflective mirror or HOE). The converged light rays pass through a waveguide 251, and are reflected by an SLM 212. The light rays reflected by the SLM 212 are transmitted to an incoupler 250 of the waveguide 251. Then, as with FIGS. 13A and 13B, the light rays are guided through the waveguide 251 to the outcoupler 252 and then converged into the eye. The coherent light source may be replaced by a self-emissive display emitting an amplitude-encoded an image, or a reflective display (e.g. a laser/coherent light source emitting light that is reflected by an amplitude modulator).

In the embodiments previously disclosed, by converging the projected light at a point forward of the centre of ocular rotation, an increased field of view is obtained (as illustrated by the image 5 formed in FIGS. 3A and 3B when compared with the image formed by the system shown in FIGS. 2A and 2B). The projection systems according to the present invention allows for a monocular field of view of 150° or greater. The native resolution of the human eye is about 60 pixels per degree, meaning a display upwards of 9000*9000 pixels would be required for such a field of view. Whilst this may be possible, the resulting display device would be expensive, bulkier, and computationally demanding in order to render such a resolution. Nonetheless, the retina has the highest sensitivity in the central foveal region, with peripheral regions having a lower sensitivity. Some projection devices may therefore incorporate a foveation portion which combines a low-resolution image for the periphery of the user's visual field with a high-resolution image for the foveal region. This reduces the requirements for resolution, bandwidth, light power, and computation. Typical display devices employ two displays (one for the high-resolution image and one for the low-resolution image), which also makes the display device more expensive and bulkier. According to one aspect of the disclosure, there is provided a foveation portion 24 of the optical system 20 of display device 10 which uses a single projection portion 21 for both images, which reduces the costs and dimensions of the system. The foveation portion 24 is actuatable to switch between a foveal mode, in which a high-resolution image is projected to the retina with a small field of view, and a peripheral mode, in which a lower-resolution image is projected to the periphery of the retina. The foveation portion 24 is controllable by computing unit 50 to switch between the foveal mode and the peripheral mode. The computing unit 50 is configured to also switch the projection portion 21 between a foveal mode and a peripheral mode in unison with the foveation portion 24, so that the projection portion 21 projects the image in a high-resolution, low field-of-view foveal mode or a lower-resolution, high field-of-view peripheral mode. In such embodiments, the computing unit 50 comprises a foveation module 545 that may be implemented in hardware, software or a combination of the two (for example stored as software in the memory 520). The foveation module comprises a sequence of instructions stored in the computing unit 50 in order to control the projection portion 21 and foveation portion 24 in unison as described herein. The foveation portion 24 may be placed at any suitable point along the optical path. For example, the foveation portion 24 may be placed after the projection portion 21 and before the steering element 22, or it may be placed after the steering element 22 and before the focusing element 23.

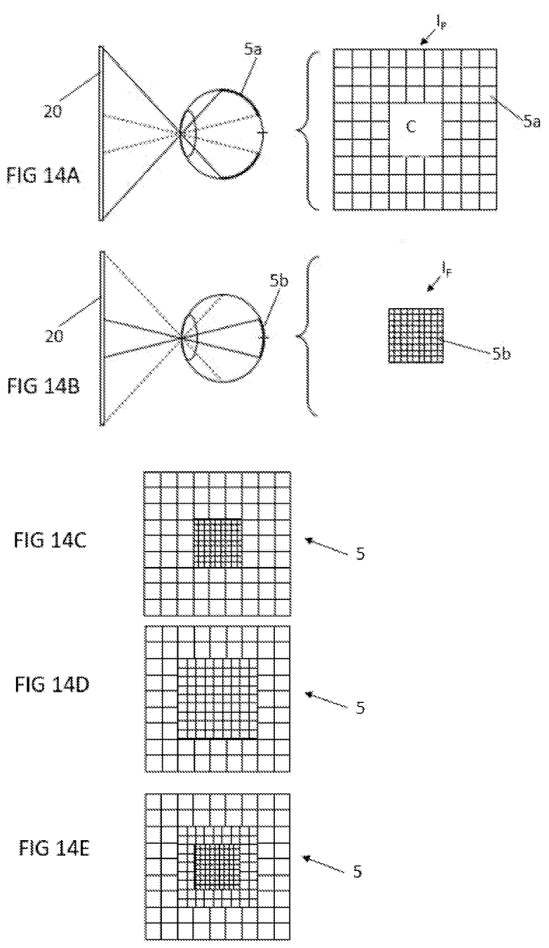

FIG. 14A shows a schematic view of an optical system 20 of a projection device operating in a peripheral mode. The optical system may be, for example, the optical system 20 of the projection device of FIG. 4 when it comprises foveation portion 24. In the peripheral mode, the optical system 20 projects a peripheral image 5a onto the retina of the eye. The peripheral image is a lower-resolution image projected onto the periphery of the retina when the eye is centred as shown. In embodiments where the steering element 22 is included in the projection device, the centre of the peripheral image 5a remains centred on the retina as the eye moves such that the peripheral image remains on the periphery of the retina. The centre C of the peripheral image 5a remains blank (i.e. no light or image is projected onto the retina in the central portion C in the peripheral mode). FIG. 14A further shows the peripheral image Ip that would be observed by the user when using the projection device.

FIG. 14B shows a schematic view of an optical system operating in a foveal mode. The optical system may be, for example, the optical system 20 of FIG. 4 when it comprises foveation portion 24. In the foveation mode, the optical system 20 projects a foveal image 5b onto the retina of the eye. The foveal image is a higher-resolution image projected onto the foveal portion of the retina, at a lower field of view, when the image is centred on a central part of the retina as shown. In embodiments where the steering element 22 is included in the projection device, the centre of the foveal image 5b remains centred on the retina as the eye moves such that the foveal image remains on the fovea of the retina. FIG. 14B further shows the peripheral image I_{f} that would be observed by the user when using the projection device.

The optical system 20 is controlled by a computing unit 50 such as the computing unit 50 shown in FIG. 5. The computing unit 50 controls the projection portion 21 and optical system 20 to switch between the foveal mode and the peripheral mode. The switching is performed at a rate high enough that the user does not perceive the switching but instead perceived a complete image 5, for example that shown in FIG. 14C, which is a combination of the foveal image 5b and the peripheral image 5a. For example, the projecting portion 21 is configured to switch between the peripheral mode and the foveal mode at a rate of 60 Hz or more (i.e. where each of the foveal image 5b and the peripheral image 5a are shown at a rate of 30 frames per second or more).

It is noted that the resolutions and fields of view of the peripheral image and the foveal image may vary depending on the requirements of the projection device. For example, as shown in FIG. 14D, the foveal image may comprise a wider field of view and a lower resolution than that shown in FIG. 14C. Furthermore, the projection device may comprise three or more foveation modes. For example, as shown in FIG. 14E, the image may comprise an inner region image with a first resolution, an inner peripheral image peripheral the inner region image having a lower resolution than the inner region image, and an outer peripheral image peripheral to the inner peripheral image having a lower resolution than the inner peripheral image. In such embodiments, the foveation portion 24 is switchable between three or more modes, each of which project an image onto the retina having different fields of views.

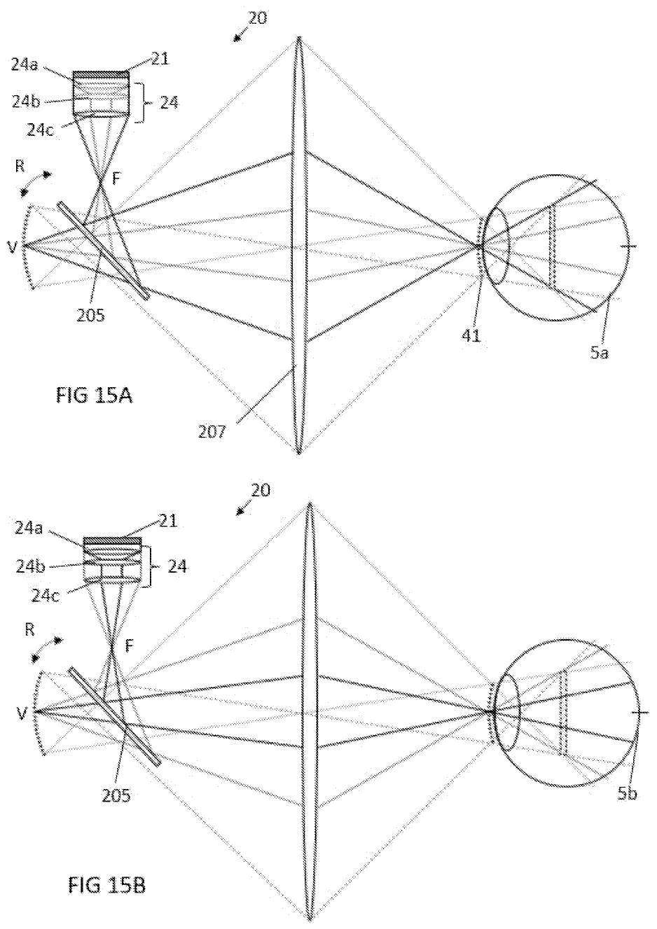

FIG. 15A shows a schematic view of an optical system 20 incorporating a foveation portion 24 according to one or more embodiments. The optical system 20 comprises a projection portion 21 which is configured to project light encoding a peripheral image to be projected onto the retina. The projection portion 21 may be any suitable projection portion for projecting images to the retina of the eye (such as any of the projection portions shown on FIGS. 6A, 6B 7A, 7B, 8A, 8B, 9A 10A, 10B, 11A, 11B or 12A). In embodiments where steering element 22 is incorporated into optical system 20 and comprises a mechanically steerable element (such as mirror 205), the projection portion 21 may for example be: a display 201 (and optionally focusing element 203) as described with reference to FIGS. 6A and 6B; a laser 210, collimating element 211 and SLM 212 (and optionally focusing element 213) as described with reference to FIG. 7A; a laser 210, focusing element 215 and SLM 212 as described with reference to FIG. 7B; or a laser 210 and steerable mirror 205′ as described with reference to FIGS. 8A and 8B.

In such embodiments, the foveation portion 24 comprises one or more switchable focusing and/or diverging elements (one or more switchable lenses or HPDLC layers) placed between the projection portion 21 and the steering element 23 (i.e. steerable mirror 205). In the peripheral mode shown in FIG. 15A, the switchable elements and the projection portion 21 are switched to the peripheral mode in which the projection portion 21 projects the peripheral image 5a to the periphery of the retina at a lower resolution and a higher field of view. FIG. 15B shows a schematic view of the optical system of FIG. 15A when in a foveal mode. In the foveal mode, the switchable elements and the projection portion 21 are switched to the foveal mode in which the projection portion 21 projects the foveal image to the fovea of the retina at a higher resolution and a lower field of view. It is noted that by switching between these two modes, the resolution of the combined image viewed by the user is double that of the resolution output by the projection portion 21, as the combined image is the combination of two images projected by the projection portion 21 (and the perceived resolution can be much higher, given the non-uniform distribution of the photoreceptors on the human retina). The steerable mirror 205 steers the image to follow the position of the retina as described in previous embodiments. It is noted that in the illustrated embodiment, the light of both the foveal and peripheral mode is converged to the same convergent point F, so that both the light of the peripheral image 5a and the foveal image 5b are converged to a point on convergent arc 41 and rotate with the position of the eye. This may be achieved by many different combinations of switchable elements. In the illustrated embodiment, in the peripheral mode only a first focusing element 24c is switched on, which converges collimated light from the projection portion 21 at point F; in the foveal mode, a second focusing element 24a and collimating element 24b are also switched on such that a narrower collimated beam is directed towards first focusing element 24c, which again converges the light to convergent point F. It would be understood that any number of elements may be switched on in the peripheral mode (e.g. two, such as a first divergent lens followed by a convergent lens, or any other suitable combination of optical elements).

FIG. 16A shows an optical system 20 comprising a foveation portion 24 for a projection device according to one or more embodiments. The optical system 20 comprises a projection portion 21 which is configured to project light encoding a peripheral image to be projected onto the retina. The projection portion 21 may be any suitable projection portion for projecting images to the retina of the eye (such as any of the projection portions shown on FIGS. 6A, 6B 7A, 7B, 8A, 8B, 9A 10A, 10B, 11A, 11B or 12A). The illustrated embodiment shows an optical system 20 comprising only a projection portion 21 and a foveation portion 24 which directly converges the projected light to a convergent point F proximal the pupil of the eye (i.e. a projection device which does not comprise a steering element 22). In such embodiments, the foveation portion 24 can also be considered as the focusing element 23. It will be understood that the foveation portion 24 described with reference to FIG. 16A could be interchanged with the foveation portion 24 described with reference to FIGS. 15A and 15B (and vice versa). In such cases, as discussed in relation to FIG. 15A the foveation portion 24 converges the projected light to a convergent point F before the steerable mirror 205 as shown in FIGS. 15A and 15B. The foveation portion 24 comprises first and second switchable focusing elements 230, 231 (such as switchable lenses, mirrors and/or HPDLC layers), which are configured to receive collimated light from the projection portion 21. The first and second lenses 230, 231 have different focal lengths and are positioned away from the projection portion 21 and apart from each other such that the convergent point F for both lenses 230, 231 coincide. In FIG. 16A, the optical system 20 is shown in a foveal mode, in which the projection portion 21 is controlled to project light encoding the foveal image 5b, first switchable focusing element 230 is switched on and second switchable focusing element 231 is switched off. The light is converged to convergent point F and the image is formed on the retina.

FIG. 16B shows the optical system 20 of FIG. 16A in a peripheral mode, in which the projection portion 21 is controlled to project light encoding the peripheral image 5a, second switchable focusing element 231 is switched on and first switchable focusing element 230 is switched off. The peripheral image is projected to convergent point F and the image is formed on the retina. The field of view of the peripheral image is wider as the second switchable focusing element 231 has a shorter focal length. It is noted that by switching between these two modes, the resolution of the combined image viewed by the user is double that of the resolution output by the projection portion 21, as the combined image is the combination of two images projected by the projection portion 21. It will be appreciated that the field of views of the foveal and peripheral images depends on the size of the collimated light projected from the projection portion, the focal lengths of the focusing elements 230 and 231, and the distance of the convergent point F to the retina.

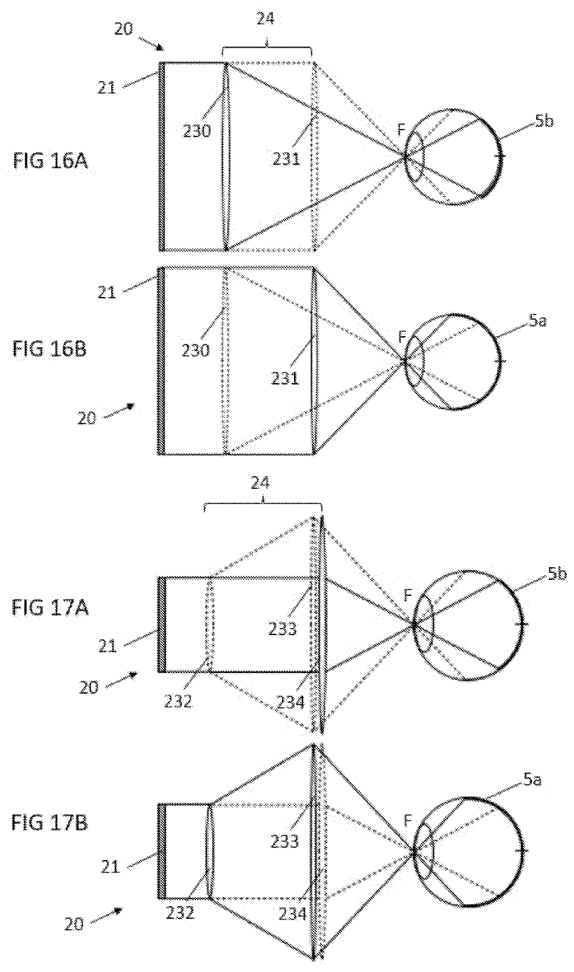

FIG. 17A shows an optical system 20 comprising a foveation portion 24 for a projection device according to one or more embodiments. The optical system 20 comprises a projection portion 21 which is configured to project light encoding a peripheral image to be projected onto the retina. The projection portion 21 may be any suitable projection portion for projection images to the retina. The illustrated embodiment shows an optical system 20 comprising only a projection portion 21 and a foveation portion 24 which directly converges the projected light to a convergent point F proximal the pupil of the eye (i.e. a projection device which does not comprise a steering element 22). In such embodiments, the foveation portion 24 can also be considered as the focusing element 23. It will be understood that the foveation portion 24 described with reference to FIG. 17A could be interchanged with the foveation portion 24 described with reference to FIGS. 15A and 15B (and vice versa). In such cases, as discussed in relation to FIG. 15A the foveation portion 24 converges the projected light to a convergent point F before the steerable mirror 205 as shown in FIGS. 15A and 15B. The foveation portion 24 comprises a switchable diverging element 232 (for example a switchable lens, convex mirror or HPDLC layer), and first and second switchable focusing elements 233, 234 (for example a switchable lens, convex mirror or HPDLC layer or any combination thereof). The switchable diverging element 232 is placed away from, and before, the first switchable focusing element 233. In FIG. 17A, the optical system 20 is shown in a foveal mode, in which the projection portion 21 is controlled to project light encoding the foveal image 5b, second switchable focusing element 234 is switched on and first switchable focusing element 233 and diverging element 232 is switched off. Collimated light encoding the image is directed from projection portion 21 to second focusing element 234, the light is converged to convergent point F and the image is formed on the retina.

FIG. 17B shows the optical system 20 of FIG. 17A in a peripheral mode, in which the projection portion 21 is controlled to project light encoding the peripheral image 5a. In the peripheral mode, second switchable focusing element 234 is switched off and first switchable focusing element 233 and diverging element 232 is switched on. The projection portion 21 projects collimated light encoding the peripheral image to switchable diverging element 232. The divergent light is directed towards first switchable focusing element 233 which converges the light to convergent point F. Peripheral image 5a is then projected onto the retina. The field of view of the peripheral image is wider as the first switchable focusing element 233 has a shorter focal length than the second switchable focusing element 231. It will be appreciated that the exact positions of elements 232, 233 and 234 depends on the focal lengths. It will be appreciated that the field of views of the foveal and peripheral images depends on the size of the collimated light projected from the projection portion, the focal lengths of the elements 232, 233 and 234, and the distance of the convergent point F to the retina. It is noted that by switching between these two modes, the resolution of the combined image viewed by the user is double that of the resolution output by the projection portion 21, as the combined image is the combination of two images projected by the projection portion 21. By using diverging element 232, advantageously the minimal space required for the optical system may be reduced. Specifically, the optical system requires a certain space which is determined in part by the focal distance of each optical elements used. In particular, in the system shown on FIGS. 16A and 16B, the switchable focusing elements 230 and 231 should be at distances to the eye corresponding to their respective focal lengths. Accordingly, these switchable focusing elements need to be spaced apart from each other, which may become a major factor in determining how compact the optical system 20 may be. By using a diverging element 232 and a separate switchable focusing element 234, the two switchable focusing elements 233 and 234 need not be spaced apart from each other.

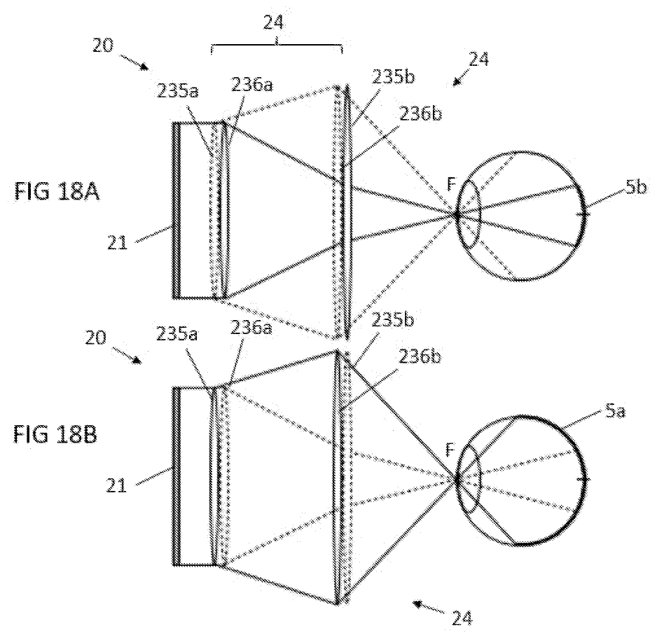

FIG. 18A shows an optical system 20 comprising a foveation portion 24 for a projection device according to one or more embodiments. The optical system 20 comprises a projection portion 21 which is configured to project light encoding a peripheral image to be projected onto the retina. The projection portion 21 may be any suitable projection portion for projection images to the retina. The illustrated embodiment shows an optical system 20 comprising only a projection portion 21 and a foveation portion 24 which directly converges the projected light to a convergent point F proximal the pupil of the eye (i.e. a projection device which does not comprise a steering element 22). In such embodiments, the foveation portion 24 can also be considered as the focusing element 23. It will be understood that the foveation portion 24 described with reference to FIG. 18A could be interchanged with the foveation portion 24 described with reference to FIGS. 15A and 15B (and vice versa). In such cases, as discussed in relation to FIG. 15A the foveation portion 24 converges the projected light to a convergent point F before the steerable mirror 205 as shown in FIGS. 15A and 15B. The foveation portion 24 comprises a first and second switchable diverging element 235a and 235b, and first and second switchable focusing elements 236a, 236b. The diverging elements and the focusing elements may be, for example, switchable lenses, switchable mirrors or HPDLC layers or any combination thereof. The first focusing element 236a is placed away from, and before, the second diverging element 235b. The first diverging element 235a is placed away from, and before, the second focusing element 236b. FIG. 18A shows the optical system 20 in a foveal mode. In the foveal mode, the first focusing element 236a and the second diverging element 236b are switched on and the first diverging element 235a and the second focusing element 236a are switched off. The projection portion 21 is controlled to project collimated light encoding the foveal image 5b to the first focusing element 236a. The first focusing element 236a converges the light towards the second diverging element 235b, which diverges the light towards convergent point F. The foveal image 5B is formed on the retina.

FIG. 18B shows the optical system 20 of FIG. 18A in a peripheral mode. In the peripheral mode, the first diverging element 235a and the second focusing element 236b are switched on and the first focusing element 236a and the second diverging element 235b are switched off. The projection portion is controlled to project collimated light encoding the peripheral image 5a to the first diverging element 235a. The first diverging element 235a diverges the light and directs the light towards second focusing element 235b, which converges the light to the same convergent point F as in the foveal mode. The peripheral image 5a is formed on the retina.

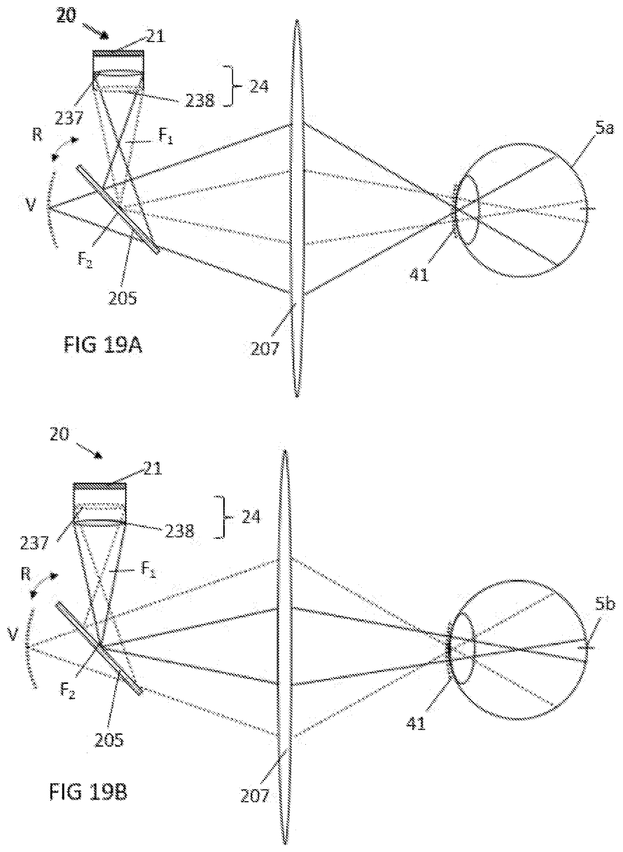

In all of the embodiments described with reference to FIGS. 14A to 18B, the convergent points F of the projected light in the foveal mode and the peripheral mode may not coincide. FIG. 19A shows an optical system 20 in a peripheral mode. In the peripheral mode, the projection portion 21 projects collimated light to the foveation portion 24 which converges the light to a convergent point F₁ before steerable mirror 205. The light is directed to focusing element 207 and the peripheral image 5a is formed on the retina. It is noted that the foveation portion 24 comprises a first switchable focusing element 237 and a second switchable focusing element 238, which operates in similar fashion to the foveation portion 24 shown in FIGS. 16B and 16B, except that in the present case the focusing elements are positioned so that the convergent points do not coincide. In the peripheral mode, the first focusing element 237 is switched on and the second focusing element 237 is switched off. It is noted that the foveation portion shown 24 could be replaced with the foveation portions of either FIG. 17A and 17B or 18A and 18B, wherein the lenses have optical properties and are positioned so that the convergent points in the foveal mode and the peripheral mode are offset from one another.

FIG. 19B shows the optical system 20 of FIG. 19A in a foveal mode. The projection portion 21 projects collimated light to the foveation portion 24 which converges the light to a convergent point F₂ which may, for example, be coincident with the surface of the steerable mirror 205. The steerable mirror 205 directs the light to the focusing element 207 which converges the light so that foveal image 5b is projected onto the retina.

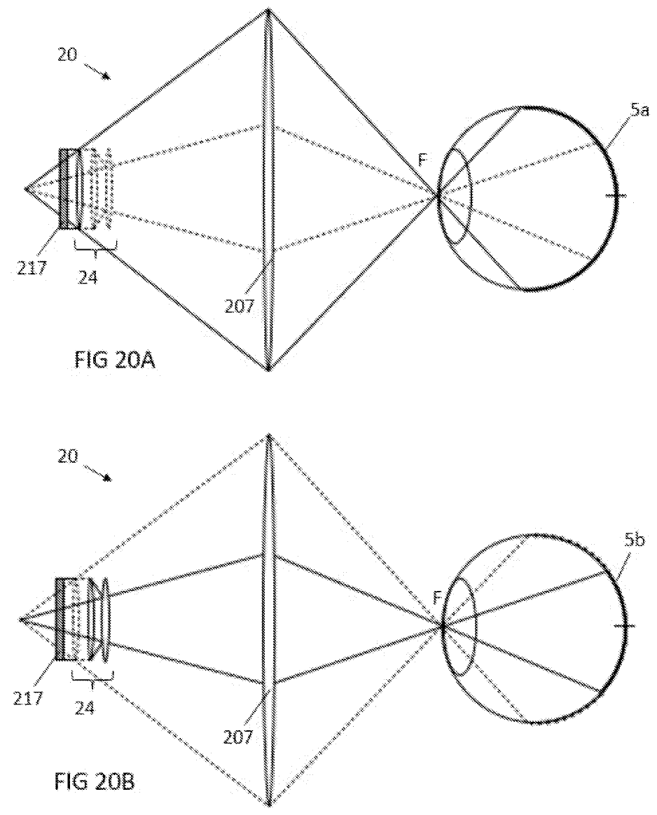

FIG. 20A shows a schematic view of an optical system 20 incorporating a foveation portion 24 according to one or more embodiments. The optical system 20 comprises a display 217 configured to emit collimated light encoding an image to be projected to the eye. The optical system further comprises a foveation portion 24, which may be any of the previously disclosed foveation portions. The display 217 and foveation portion 24 are mounted to a steerable element such as a MEMS. In FIG. 20A the optical system 20 is shown operating in a peripheral mode. In this mode, the display 217 projects light encoding the peripheral image. The foveation portion 24 is switched to the peripheral mode and diverges the light to a wide angle and the focusing element 207 converges the light to convergent point F, and the peripheral image 5a is projected onto the retina. The steerable element allows the peripheral image 5a to remain centred on the retina as described in previous embodiments.

FIG. 20B shows the optical system 20 of FIG. 20A operating in a foveal mode. The display 217 projects light encoding the foveal image. The foveation portion 24 is switched to the foveal mode and diverges the light to a narrower angle than the peripheral mode and the focusing element 207 converges the light to convergent point F (coincident with the convergent point in the peripheral mode) and the foveal image 5b is projected onto the retina. The steerable element allows the foveal image to remain centred on the retina as described in previous embodiments.

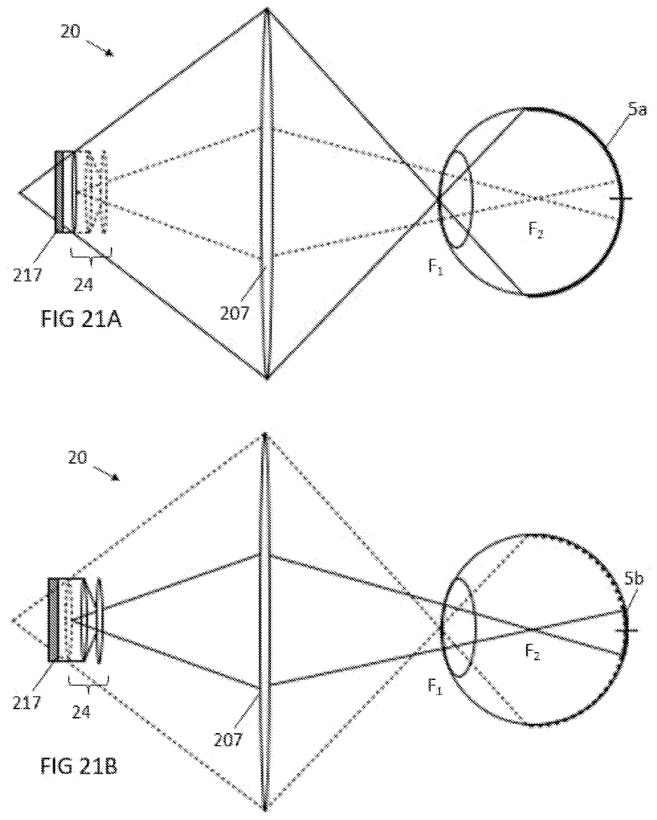

As previously discussed, the projected light in the peripheral mode and the foveal mode by the focusing element 207 need not have a coincident convergent point. FIGS. 21A and 21B show an optical system 20 similar to FIGS. 20A and 20B, except that the optical elements for each mode of foveation portion 24 are selected such that in the peripheral mode, the projected light is converged to convergent point F₁, and in the foveal mode the projected light is converged to convergent point F₂ offset from F₁. The offset may be defined to be substantially about the optical axis of the eye, the pupillary axis of the eye or an axis formed by the pupil and the centre of ocular rotation.

In exemplary embodiments described above, the optical system 20 comprises a foveation portion 24 using elements separate from the projection portion 21 and the focusing portion. However, this is non-limiting, as a foveated display may be provided without requiring separate optical elements for the foveation portion (which may, therefore, be omitted).

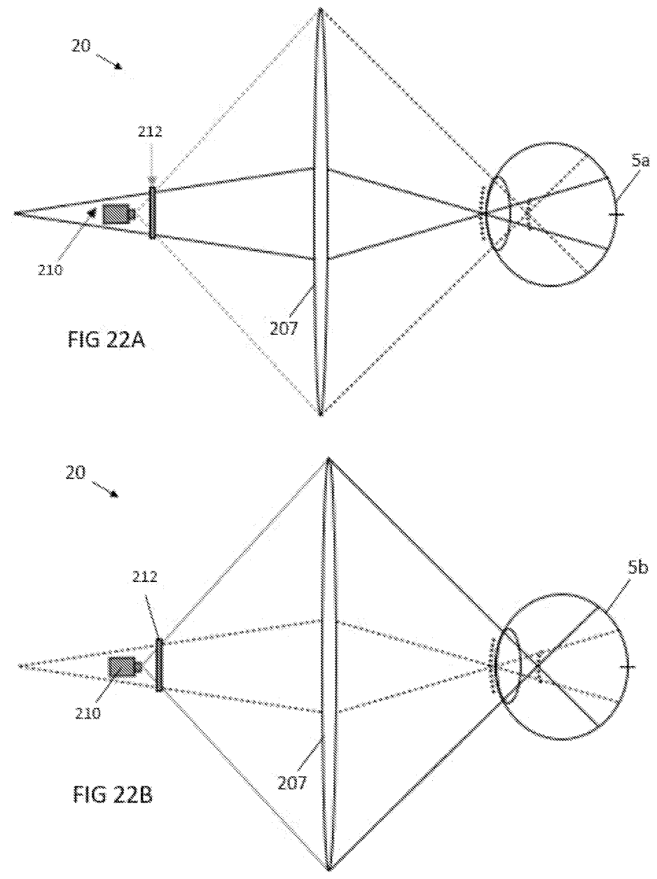

FIGS. 22A and 22B show schematic views of an optical system 20 configured to provide a foveated display according to one or more embodiments.

Specifically, as described in connection with FIG. 11A above, a laser 210 is configured to emit divergent light to a phase modulator 212 (e.g. a reflective or transmissive SLM or DLP), and the phase modulator 212 is configured to spatially modulate the light to steer the beam in a given direction.

FIG. 22A shows the optical system 20 in a foveal mode. The laser 210 and the phase modulator 212 transmit the light onto a central portion of the focusing element 207 (which is shown by way of non-limiting example as a lens). The focusing element 207 converges the light from its central portion onto a convergent point located near the pupil of the eye. The converged light rays enter the eye and projects a foveal image 5a onto a central portion 5a (e.g. fovea) of the retina.

FIG. 22B shows the optical system 20 in the peripheral mode. The laser 210 and phase modulator 212 transmit light onto a wider portion of the focusing element 207 (wider than the central portion used in the foveal mode). The focusing element 207 converges the light from the wider portion into the eye, and the light projects a peripheral image 5b onto the retina.

It would be understood that the implementation shown on FIGS. 22A and 22B is a non-limiting example. Instead, the focusing element 207 may cause, in the foveal mode, the light to be convergent onto a convergent point nearer the centre of ocular rotation (i.e. the centre of the sphere representing the eye), and in the foveal mode, onto a convergent point nearer the pupil (i.e. the position of the convergent points in the foveal and peripheral modes may be the opposite to the example shown on FIGS. 22A and 22B). In other examples, one of the convergent point (in either one of the foveal mode and the peripheral mode) may be located forward of the eye, and the other convergent point (in the other one of the foveal mode and the peripheral mode) be located between the pupil and the centre of ocular rotation.

Advantageously, with this optical system, no movable element is required, and no additional optical elements is required to provide a foveated display. Accordingly, the optical system 20 may be made more compact and require less resources to operate.

As with the exemplary embodiments shown in FIGS. 10A and 10B, an optical system 20 without moving part may project different images onto a central portion of the retina and a peripheral portion of the retina.

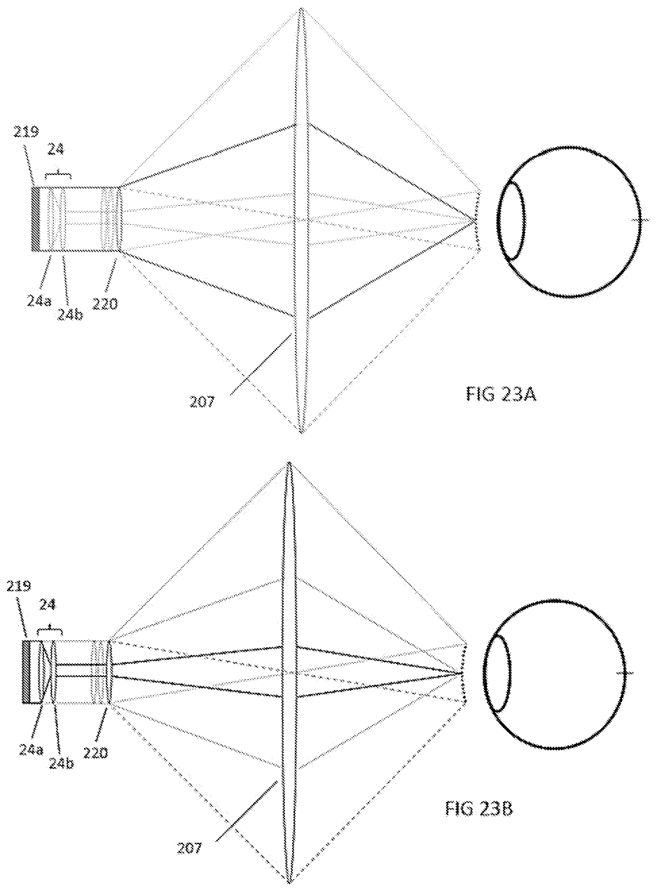

FIGS. 23A and 23B show schematic views of an optical system 20 configured to provide a foveated display according to one or more embodiments.

The optical system 20 comprises a display 219, a foveation portion 24, a steering portion (shown by way of non-limiting example as a stack of HPDLC 220) and a focusing element 207 (shown by way of non-limiting example as a lens). The foveation portion comprises one or more switchable optical elements (e.g. converging or diverging elements).

FIG. 23A shows the optical system 20 in a peripheral mode. The display 219 emits collimated light rays onto the foveation portion 24. In the peripheral mode, the switchable elements of the foveation portion 24 are switched off, and thus let the collimated light rays from the display 219 substantially without altering an angular size of the light rays (i.e. leaving the light rays collimated).

The collimated light rays are transmitted to the steering portion 220, which steers the light rays as explained in connection with FIGS. 10A and 10B above, the explanation of which will be omitted here for brevity.

FIG. 23B shows the optical system 20 in the foveal mode. In the foveal mode, the switchable elements of the foveation portion 24 are switched on. Accordingly, the focusing element 24a focuses the collimated light rays from the display 219. The collimating element 24b collimates the focused light rays, which are transmitted to the steering portion 220. In the foveal mode, the light rays collimated by the collimating element 24b reach a narrower part of the steering portion 220 (e.g. the collimated light rays are projected onto a central part of the HPDLC stack) than in the peripheral mode. Accordingly, the light rays reach the focusing element 207, and by consequence the eye, in a narrower angular range in the foveal mode than in the peripheral mode.

Although in the example shown on FIGS. 23A and 23B, the foveation portion 24 comprises a focusing element 24a and collimating element 24b, this is non-limiting, as it would be understood that any number of switchable optical elements may be provided. More generally, the foveation portion may instead correspond to the foveation portions described in any of the exemplary embodiments herein, for example the foveation portion shown on any of FIGS. 15A-15B, 16A-16B, 17A-17B, 18A-18B, 19A-19B, 20A-20B, 21A-21B, etc.).

Embodiments described above use the example of a display emitting light rays that encode an image. In some embodiments, the display may be a light-field display which is configured to project the light encoding a plurality of elemental images in a three-dimensional light field.

FIG. 24A shows a schematic view of an optical system 20 configured to provide a light-field display according to one or more embodiments.

The optical system 20 comprises a light-field display 260 and a focusing element 203 (as an example of a projection portion 21), a rotatable mirror 205 (as an example of a steering portion 22), and a focusing element 207 (as an example of a focusing portion 23).

The focusing element 203, rotatable mirror 205 and focusing element 207 operate as explained in connection with FIG. 6A above, thus some explanation on these elements will be omitted here for brevity.

The light-field display 260 emits light rays that encoding a plurality of elemental images in a three-dimensional light field. Each elemental image is rendered so as to be perceived by the user to be arriving from a virtual point in the environment. FIG. 24A shows two exemplary virtual points, V1 and V2, although it would be understood that any other number of virtual points may be provided.

The light rays corresponding to the virtual point VI are reflected off the rotatable mirror 205 and through the focusing element 207, to converge at point V1′ on the retina. As these light rays converge on a point located on the retina. The elemental image encoded in these light rays appear in-focus to the user.

Similarly, the light rays corresponding to the virtual point V2 are reflected off the rotatable mirror 205 and through the focusing 207 to be projected into the eye. However, the light rays corresponding to the virtual point V2 converge at a point V2′ that is forward of the retina. Accordingly, these light rays are projected onto a region of the retina indicated by V2″. Because these light rays are not focused on a point when reaching the retina, the elemental image encoded by these light rays are blurred (i.e. they appear out-of-focus to the user).

Accordingly, the user will perceive the elemental image encoded by the light rays corresponding to the virtual point V2 to be at a depth different from the elemental image encoded by the light rays corresponding to the virtual point V1. The image displayed by the light-field display therefore gains a third dimension with the depth perceived by the user.

It would be understood that, in the example shown on FIG. 24C, the light rays focused by the focusing element 207 focus on a plurality of convergent points on the convergent arc near the pupil. By way of non-limiting example, FIG. 24A shows three convergent points C1, C2 and C3.

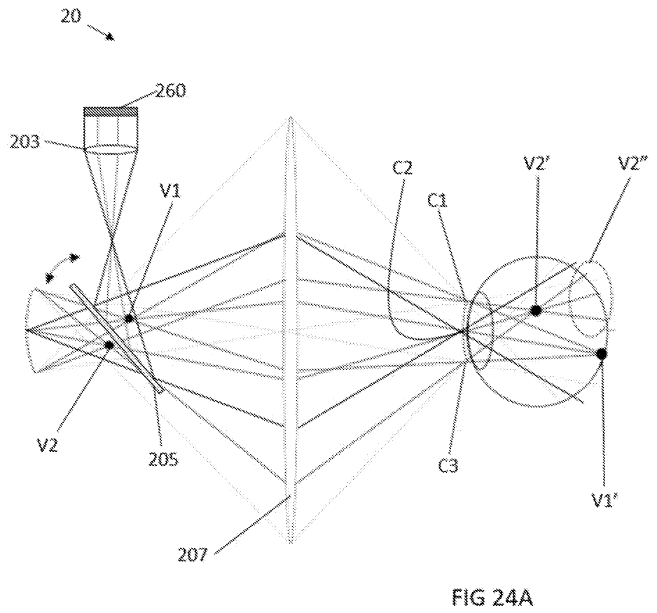

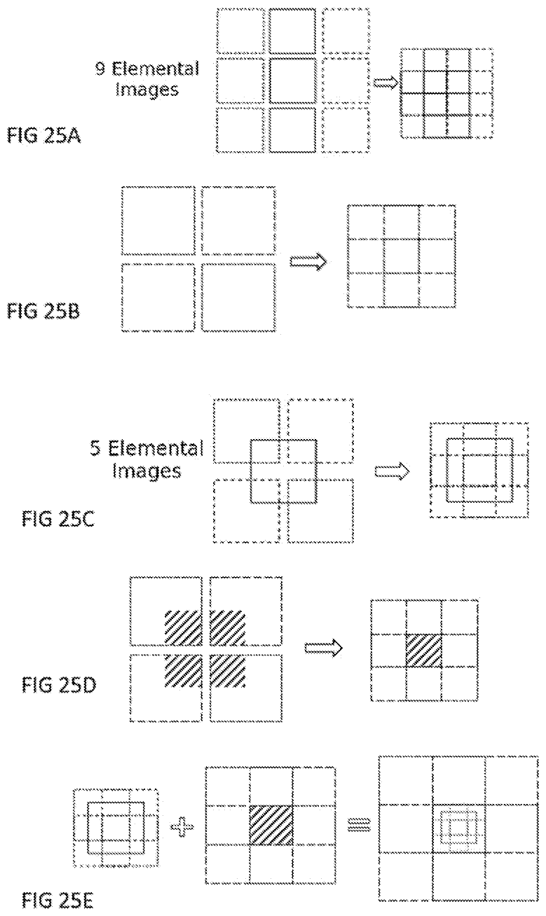

FIGS. 25A-25E show schematic views illustrating different combinations of elemental images that may be encoded in light from a light-field display.

As shown on FIGS. 25A, 9 elemental images with varying perceived depths may be combined to form a three-dimensional light-field. Specifically, the images in the middle column may correspond to a first perceived depth (as shown by the continuous lines), the images in the left column may correspond to a second perceived depth (as shown by the dotted lines), and the images in the right column may correspond to a third perceived depth (as shown by the dashed lines), where the first, second and third perceived depths are different from each other. The 9 elemental images have a partial overlap with adjacent images, such that the user perceives the image with elements having varying depths.

The number of elemental images, the configuration or the perceived depth of each image is not limited to the example of FIG. 25A. Specifically, the number of elemental images may be different, for example four elemental images may be used as shown on FIG. 25B,, and/or a different configuration (i.e. the elemental images need not be configured in columns with equal number of elemental images).

In addition, the partial images need not overlap. For example, as shown on FIG. 25D, a part corresponding to each elemental image that would overlap with other elemental images when combined (the shaded portions on FIG. 25D) may be omitted. In such cases, a single one of the elemental images (for example the elemental image in the top-right) may include the corresponding shaded portion, so the combined image is complete.

As shown on FIG. 25E, the light-field display may also be used to display different three-dimensional light fields to a central portion of the retina and to a peripheral portion of the retina. For example, a light field using five elemental images (with the configuration shown on FIG. 25C) may be projected onto the central portion, and a light field using four elemental images (with the configuration shown on FIG. 25D) may be projected onto the peripheral portion. It would be understood that the number of elemental images described herein are purely exemplary, and any number of elemental images may be used instead.

Having described various examples of three-dimensional light-fields that may be provided, other details of light-field display that would now become apparent to a person skilled in the art will be omitted here, for brevity.

### MODIFICATIONS AND VARIATIONS

Many modifications and variations can be made to the example embodiments described above.

Although FIG. 4 shows the optical system 20 with the steering portion 22 and the foveation portion 24, in some embodiments, either or both of the steering portion 22 and the foveation portion 24 may be omitted.

For example, as shown on any of FIGS. 6A to 13C, the optical system 20 need not project different images onto a central region of the retina and a peripheral region of the retina.

As another example, as shown for example on FIG. 10A or 10B, the projection portion 21 may be configured to emit light in different directions, thus removing the need for a steering portion 22.

Furthermore, in cases where the optical system 20 comprises a foveation portion, the optical system 20 need not cause the convergent point to move along the convergent arc (in case of a dynamic eye-box).

Although example embodiments described above use specific optical elements, it would be understood each of these may be replaced by other, interchangeable optical elements. For example, each divergent lens may be replaced by a convex mirror, each convergent lens may be replaced by a concave mirror, or each lens or mirror may be replaced by an HPDLC, an HOE, a stacked HPDLC, etc.

Although in example embodiments described above, mirrors or other rotatable elements are shown as having one axis of rotation, these may have two distinct axes of rotation (or the optical system 20 may comprise additional rotatable element(s) configured to rotate along a second distinct axis of rotation, thus allowing the optical system to control the location of the convergent point(s) of the light rays along two dimensions.

In example embodiments described above, the image projected into the eye may be a part of a scene (such as a still image or video, showing one or more virtual elements). The part of the scene being projected may correspond to the angle of rotation of the eye (i.e. the orientation of the pupil), such that the part being projected changes as the eye moves.

In other cases, for example when a dynamic eye-box is used (and the optical system causes the convergent point(s) to move along the convergent arc or the convergent surface), the displayed image could instead remain fixed in the field of view of user. In other words, the image seen by user may be static and not move in user's vision.

In any of the example embodiments described above comprising a phase modulator, the optical system may be configured to project the light encoding a holographic image. For example in FIG. 7A, the phase modulator 212 may be configured to project light encoding a holographic image, by combining wavefronts. For brevity, details of holographic image generation and projection that would now become apparent to the person skilled in the art will be omitted, for brevity.

In example embodiments described above with reference to FIGS. 17A and 17B, include two switchable focusing elements 233 and 234, each being used to converge the light in one of the foveal mode and the peripheral mode. Alternatively, a single switchable focusing element may be used and controlled to switch between a first state and a second state (e.g. in the first state when the foveation portion is in the foveal mode and in the second state when the foveation portion is in the peripheral mode, or vice-versa), where the single switchable focusing element may have different focal length in the first state and the second state.

In example embodiments described above with reference to FIGS. 18A and 18B, the first switchable diverging element 235a and the first focusing element 236a may be replaced by a single switchable optical element (where, in the foveal mode, the single switchable optical element has a focal length corresponding to the first switchable diverging element 235a, and in the peripheral mode, the single switchable optical element has a focal length corresponding to the first focusing element 236a). Additionally or alternatively, the elements 235b and 236b may be replaced by a single switchable optical element.

In the foregoing description, example aspects are described with reference to several example embodiments. Accordingly, the specification should be regarded as illustrative, rather than restrictive. Similarly, the figures illustrated in the drawings, which highlight the functionality and advantages of the example embodiments, are presented for example purposes only. The architecture of the example embodiments is sufficiently flexible and configurable, such that it may be utilized in ways other than those shown in the accompanying figures.

Some embodiments may also be implemented by the preparation of application-specific integrated circuits, field-programmable gate arrays, or by interconnecting an appropriate network of conventional component circuits.

The apparatuses described herein may be embodied in other specific forms without departing from the characteristics thereof. The foregoing embodiments are illustrative rather than limiting of the described systems and methods. Scope of the apparatuses described herein is thus indicated by the appended claims, rather than the foregoing description, and changes that come within the meaning and range of equivalence of the claims are embraced therein.

1-31. (canceled)

32. An optical system for a near-eye projection of an image into an eye of a user, the optical system comprising:
a projection portion configured to project light encoding the image, and
a foveation portion comprising at least one switchable optical element controllable to switch between a foveal mode and a peripheral mode, wherein
in the foveal mode, the foveation portion is configured to project the light from the projection portion on a central region of a retina of the eye, and
in the peripheral mode, the foveation portion is configured to project the light from the projection portion on a peripheral region of the retina, the peripheral region being larger than and comprising the central region.

33. The optical system according to claim 32, wherein the projection portion is configured to project the light as substantially collimated light.

34. The optical system according to claim 32, wherein each of the at least one switchable element is configured to, when switched to a first state, allow the light to pass substantially without altering an angular size of the light.

35. The optical system according to claim 32, wherein the foveation portion is configured to increase an angular size of the light incident on the eye in the peripheral mode.

36. The optical system according to claim 32, wherein the foveation portion is configured to increase a focal length of the light incident on the eye in the foveal mode.

37. The optical system according to claim 36, wherein the foveation portion comprises at least one focusing element having a controllable focal length.

38. The optical system according to claim 32, wherein the at least one switchable optical element comprises a first switchable element having a first focal length and a second switchable element having a second focal length, the second focal length being different from the first focal length.

39. The optical system according to claim 38, wherein the first switchable element is arranged at a first distance from the display and the second switchable element is arranged a second distance from the display.

40. The optical system according to claim 39, wherein a difference between the first distance and the second distance is such that a convergent point of the first switchable element and a convergent point of the second switchable element coincide substantially with each other.

41. The optical system according to claim 38, wherein
in the foveal mode, the first switchable element is configured to be switched to a second state and the second switchable element is configured to be switched to a first state, and
in the peripheral mode, the first switchable element is configured to be switched to a first state and the second switchable element is configured to be switched to a second state.

42. The optical system according to claim 32, wherein the at least one switchable optical element comprises a first switchable diverging element, a first switchable converging element, and a second switchable converging element,
wherein the first switchable diverging element is arranged a first distance from the projection portion, and the first switchable converging element is arranged a second distance from the projection portion, the second distance being greater than the first distance.

43. The optical system according to claim 42, wherein,
in the foveal mode, the first switchable diverging element is configured to be switched to a first state, the first switchable converging element is configured to be switched to a first state, and the second switchable converging element is configured to be switched to a second state, such that the light from the projection portion is converged by the second switchable converging element to form an image on the central region of the retina, and
in the peripheral mode, the first switchable diverging element is configured to be switched to a second state, the first switchable converging element is configured to be switched to a second state, and the second switchable converging element is configured to be switched to a first state, such that the light from the projection portion is diverged by the first switchable diverging element onto the first switchable converging element and converged by the first switchable diverging element to form an image on the peripheral region of the retina.

44. The optical system according to claim 42, wherein the second switchable converging element is arranged a third distance from the projection portion, such that a convergent point of the first switchable converging element and a convergent point of the second switchable converging element coincide substantially with each other.

45. The optical system according to claim 42, wherein the at least one switchable optical element further comprises a second switchable diverging element,
wherein the second switchable diverging element is configured to be switched to a second state in the foveal mode and to increase an angular size of the light converged by the first switchable converging element,
wherein the second switchable converging element is arranged a third distance from the projection portion, and the second switchable diverging element is arranged a fourth distance from the projection portion,
wherein the first distance, the second distance, the third distance and the fourth distance are configured such that a convergent point of the light in the foveal mode and a convergent point of the light in the peripheral mode coincide substantially with each other.

46. The optical system according to claim 32, wherein the foveation portion is configured to converge the light to at least one convergent point so as to cause the projected light to enter the eye and form an image on the retina,
wherein the at least one convergent point is located on a convergent arc on or near a pupil of the eye, wherein a respective location of each convergent point on the convergent arc corresponds to an angle of rotation of the eye about an ocular rotation axis, the convergent arc having a centre of curvature substantially coincident with the ocular rotation axis.

47. The optical system according to claim 46, wherein the optical system is configured to move the at least one convergent point so that a central portion of the image coincides substantially with a central region of a retina of the eye, a macula of the retina, or one of a perifovea, a parafovea, a fovea, a foveal avascular zone, a foveola, and an umbo of the retina.

48. The optical system according to claim 47, further comprising a steering portion configured to move the at least one convergent point about the convergent arc in response to a rotation of the eye about an ocular rotation axis, the arc having a centre of curvature substantially coincident with the ocular rotation axis.

49. The optical system according to claim 48, wherein the steering portion is configured to move at least one element of the projection portion and the foveation portion.

50. The optical system according to claim 48, wherein the steering portion comprises at least one optical element for steering the light from the projection portion towards the foveation portion.

51. The optical system according to claim 50, wherein the at least one optical element comprises at least one of a steerable mirror, a phase modulator with controllable phase modulation, or a plurality of switchable lenses, each switchable lens having a respective orientation and configured to orient the light from the projection portion onto a different portion of the foveation portion, such that the foveation portion converges the light on a different convergent point on the convergent arc.

52. The optical system according to claim 32, wherein
the projection portion is configured to project a plurality of light each encoding a respective portion of an image and the foveation portion is configured to converge each light on a corresponding one of a plurality of convergent points, the location of each convergent point on the convergent arc corresponding to a respective angle of rotation of the eye about the ocular rotation axis, such that the light converging on adjacent convergent points encode adjacent portions of the image.

53. The optical system according to claim 46, wherein the at least one convergent point is located on a convergent surface, the convergent surface being substantially parallel to the pupil of the eye and comprising the convergent arc.

54. The optical system according to claim 32, wherein the projection portion comprises a display configured to emit the image to be displayed in substantially collimated light rays, and a focusing element for converging the light rays towards the foveation portion,
wherein the projection portion comprises a spatial filter for receiving the converged light rays.

55. The optical system according to claim 32, wherein the projection portion comprises a coherent light source or a laser configured to emit substantially coherent light,
wherein, the projection portion comprises at least one of
a collimating element configured to collimate the substantially coherent light,
a phase modulator configured to encode the image by modulating the substantially coherent light, and
a laser beam scanning system comprising at least one steerable mirror.

56. The optical system according to claim 32, wherein the projection portion comprises a light-field display configured to project the light encoding a plurality of elemental images in a three-dimensional light field, each elemental image forming a part of the image.

57. The optical system according to claim 32, wherein the projection portion comprises a phase modulator configured to project the light encoding a holographic image.

58. A projection device comprising the optical system according to claim 32, and an eye tracker for determining an angle of rotation of the pupil of the eye,
wherein the eye tracker comprises at least one camera for capturing an image of the eye, the eye tracker being configured to determine the angle of rotation of the pupil of the eye based on the image, the angle of rotation of the pupil being used to determine the location of the at least one convergent point on the convergent arc,
the eye tracker is configured to determine a focal length of the lens of the eye, and
the eye tracker comprises at least one a light source for illuminating the eye.

59. A method for a near-eye projection of an image into an eye of a user, the optical system comprising:
projecting light encoding the image, and
controlling at least one switchable optical element to switch between a foveal mode and a peripheral mode, wherein
in the foveal mode, the light encoding the image is projected by the at least one switchable optical element on a central region of a retina of the eye, and
in the peripheral mode, the light encoding the image is projected by the at least one switchable optical element on a peripheral region of the retina, the peripheral region being larger than and comprising the central region.
